(19) United States
(12) Patent Application Publication
(10) Pub. No.: US 2025/0069301 A1
(43) Pub. Date: Feb. 27, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventor: YUKI ONO, TOKYO (JP)

(21) Appl. No.: 18/724,646

(22) PCT Filed: Dec. 23, 2022
(86) PCT No.: PCT/JP2022/047534

§ 371 Date: Jun. 27, 2024

(30) Foreign Application Priority Data
Jan. 6, 2022 (JP) 2022-001234

(51) Int. Cl. G06T 11/60; G06V 20/20; H04N 23/60

(52) U.S. Cl. CPC G06T 11/60; G06V 20/20; H04N 23/64

(57) ABSTRACT

The present disclosure relates to an information processing device, an information processing method, and a program that make it easy to use an application program to which XR technology is applied in a plurality of client devices. When local maps generated by client devices are combined to generate a global map, and SLAM initialization processing for the global map is executed in a server, and, in a case where the combination of the local maps fails, the server transmits guide information for solving the failure of the combination according to a cause of the failure to the client device and presents the guide information to a user. The present disclosure is applicable to an application program using XR technology.

### TECHNICAL FIELD

The present disclosure relates to an information processing device, an information processing method, and a program and more particularly to an information processing device, an information processing method, and a program that make it easy to use an application program to which XR technology is applied in a plurality of client devices.

### BACKGROUND ART

Technologies using augmented reality (AR), virtual reality (VR), mixed reality (MR), and the like, which are collectively referred to as extended reality (XR), are becoming popular.

In an application program that is one of the technologies using XR, a self-localization technology called simultaneous localization and mapping (SLAM) is used to superimpose and display computer graphics (CG) without discomfort according to a position and posture (direction of device) of a device forming a client device.

As a technology using this SLAM and VR technology, for example, a technology for avoiding a risk that a user in a digital space collides with a real obstacle has been proposed (see Patent Document 1).

By the way, conventionally, SLAM is individually operated in client devices, and CG is superimposed and displayed on the basis of individual self-localization results.

Meanwhile, with dramatic improvement in communication performance of the fifth generation mobile communication system (5G) and the like in recent years, a plurality of client devices can share mutual self-localization results in common and superimpose and display CG on the basis of shared position information estimation results.

Therefore, for example, in a game using XR technology, common CG can be superimposed and displayed on the client devices of a plurality of users according to positions and postures thereof, and the plurality of users can have a common experience in real time while using the respective client devices.

Further, in a game or the like using XR technology, even users physically separated from each other can interact with each other while grasping a positional relationship therebetween in a digital space displayed on each client device.

By the way, SLAM needs to be initialized in an application program using those XR technologies.

The SLAM initialization is processing of combining local maps generated by individual client devices, unifying the local maps such that the local maps can be used in a common coordinate system, and generating a global map that comprehensively shows mutual self-localization results of the plurality of client devices. When the SLAM initialization is performed, the global map generated in the processing is sequentially updated.

Therefore, a technology of speeding up this SLAM initialization to implement processing by an application program using XR technology has been proposed (see Patent Document 2).

Further, there has also been proposed a technology of, when a plurality of users uses respective client devices to execute an application program using XR technology, connecting each client device on a worldwide map using a satellite image and implementing processing corresponding to the above SLAM initialization (see Patent Document 3).

Furthermore, there has also been proposed a technology of updating a global map available in a common coordinate system according to a change in environment while a plurality of users is using respective client devices and is sharing an experience using XR technology (see Patent Document 4).

### CITATION LIST

### Patent Document

Patent Document 1: Japanese Patent Application Laid-Open No. 2021-2290
Patent Document 2: Japanese Translation of PCT International Application Publication No. 2016-502712
Patent Document 3: Japanese Patent Application Laid-Open No. 2021-111385
Patent Document 4: Japanese Patent Application Laid-Open No. 2011-186808

### SUMMARY OF THE INVENTION

### Problems to be Solved by the Invention

In the above SLAM initialization for a global map in an application program used by a plurality of client devices, in some cases, a global map cannot be generated due to various factors such as a failure in which a local map cannot be generated for some reason in each client device or a failure in which local maps cannot be combined, and thus the SLAM initialization fails.

In a case where the SLAM initialization for a global map fails, a user can take an action for solving the failure, for example, if the user knows the cause of the failure.

However, in a case where the SLAM initialization for a global map fails, in general, an application program to which XR technology is applied just becomes unusable, and the cause thereof is unknown. Therefore, the user cannot do anything, that is, cannot solve the unusable state of the application program to which XR technology is applied.

The present disclosure has been made in view of such a situation and, in particular, allows a user to easily solve a failure of SLAM initialization for a global map by himself/herself when a plurality of client devices uses an application program to which XR technology is applied.

### Solutions to Problems

An information processing device and a program according to one aspect of the present disclosure are an information processing device and a program including a generation unit that generates a global map by combining local maps generated by a respective plurality of other information processing devices, in which, in a case where the combination of the local maps fails, the generation unit presents guide information for solving the failure of the combination of the local maps.

An information processing method according to one aspect of the present disclosure is an information processing method including the steps of: generating a global map by combining local maps generated by a respective plurality of other information processing devices; and, in a case where the combination of the local maps fails, presenting guide information for solving the failure of the combination of the local maps.

In one aspect of the present disclosure, a global map is generated by combining local maps generated by a respective plurality of other information processing devices, and, in a case where the combination of the local maps fails, guide information for solving the failure of the combination of the local maps is presented.

### BRIEF DESCRIPTION OF DRAWINGS

FIG. 1 shows local maps and a global map.

FIG. 2 shows an example of generating a global map on the basis of local maps.

FIG. 3 shows an example of generating a global map on the basis of local maps.

FIG. 4 shows processing of generating a global map on the basis of local maps in the present disclosure.

FIG. 5 shows an overview of the present disclosure.

FIG. 6 is a block diagram showing a configuration example of a preferred embodiment of a communication system of the present disclosure.

FIG. 7 shows a configuration example of a client device in FIG. 6.

FIG. 8 shows a configuration example of a server in FIG. 6.

FIG. 9 shows a data structure of a local map and a global map.

FIG. 10 shows a method of detecting a position and a posture and a mapping method based on a key frame.

FIG. 11 shows a method of combining local maps.

FIG. 12 shows causes of a failure of combination of local maps and solution methods thereof.

FIG. 13 shows a display example of guide information when a cause of a combination failure is absence of a common field of view.

FIG. 14 shows a display example of guide information when a cause of a combination failure is absence of a common field of view.

FIG. 15 shows a display example of guide information when a cause of a combination failure is interruption of communication.

FIG. 16 shows a display example of guide information when a cause of a combination failure is insufficient key points serving as feature points.

FIG. 17 shows a display example of guide information when a cause of a combination failure is insufficient motion parallax.

FIG. 18 is a flowchart showing SLAM initialization processing by the client device in FIG. 7.

FIG. 19 is a flowchart showing SLAM initialization processing by the server in FIG. 8.

FIG. 20 is a flowchart showing failure notification processing of the flowchart in FIG. 19.

FIG. 21 shows an example of guide information displayed when an object recognition unit is provided in a client device in a communication system of the present disclosure.

FIG. 22 shows a configuration example of the client device in FIG. 6 in which an object recognition unit is provided.

FIG. 23 is a flowchart showing SLAM initialization processing by the client device in FIG. 22.

FIG. 24 is a flowchart showing an application example of the failure notification processing of the flowchart in FIG. 19.

FIG. 25 shows a configuration example of a general-purpose computer.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configurations are denoted by the same reference signs, and redundant descriptions are omitted.

Hereinafter, modes for carrying out the present technology will be described. The description will be made in the following order.
1. Preferred embodiment
2. Application example
3. Example of execution by software

### 1. Preferred Embodiment

### <Overview of Present Disclosure>

In particular, in a case where generation of a global map fails, the present disclosure presents guide information according to a cause of the failure, thereby allowing a user to easily solve the failure of the generation of the global map by himself/herself, and makes it easy to use an application program to which XR technology is applied in a plurality of client devices.

In an application program using extended reality (XR) technology that is a general term for augmented reality (AR), virtual reality (VR), mixed reality (MR), and the like, a self-localization technology called simultaneous localization and mapping (SLAM) is used to superimpose and display computer graphics (CG) without discomfort according to a position and posture (direction of device) of a device forming a client device.

Conventionally, a plurality of client devices individually operates SLAM and superimposes and displays CG on the basis of their respective self-localization results.

Meanwhile, with dramatic improvement in communication performance of the fifth generation mobile communication system (5G) and the like in recent years, the plurality of client devices can share mutual relative self-localization results in common and superimpose and display CG on the basis of shared information.

Therefore, for example, in a game using XR technology, common CG is superimposed and displayed on the client devices of a plurality of users according to positions and postures thereof, and thus the plurality of users can have a common experience in real time while using the respective client devices.

By the way, SLAM is initialized in an application programs using those XR technologies.

The SLAM initialization is processing of combining local maps generated on the basis of self-position information estimated by SLAM in the individual client devices, unifying the local maps such that the local maps can be used in a common coordinate system, and generating a global map that comprehensively shows a relative positional relationship between the plurality of client devices.

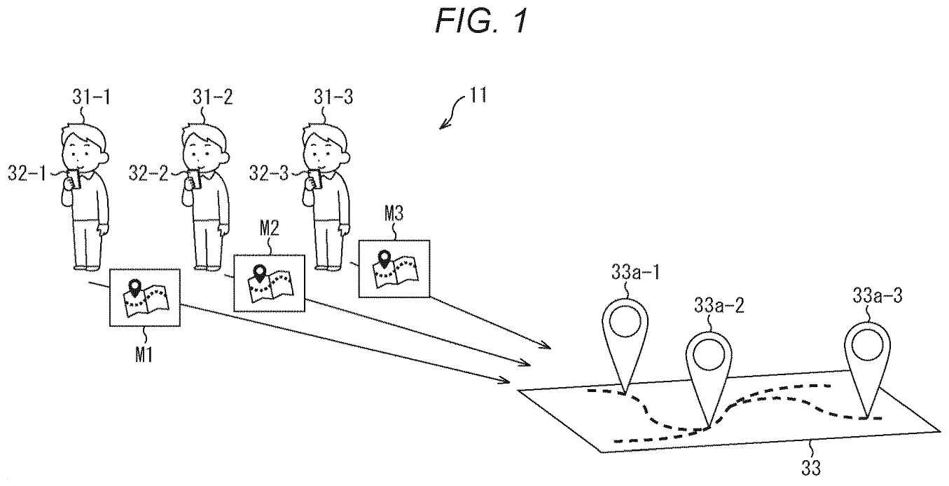

Here, the SLAM initialization will be specifically described with reference to a communication system 11 of FIG. 1.

In the communication system 11 of FIG. 1, users 31-1 to 31-3 possess respective client devices 32-1 to 32-3 such as smartphones and tablets, for example, and the client devices 32-1 to 32-3 individually execute SLAM to estimate their self-positions and generate local maps M1 to M3.

Note that, in a case where it is unnecessary to distinguish the users 31-1 to 31-3 and the client devices 32-1 to 32-3 in particular, the users and the client devices will be simply referred to as the users 31 and the client devices 32, and other configurations will also be referred to in a similar manner.

Further, it is assumed that the users 31-1 to 31-3 exist in a common space (either a real space or a virtual space) in which the users can recognize mutual positional relationships.

In FIG. 1, the local maps M1 to M3 of the respective client devices 32-1 to 32-3 are combined and unified to be used as a common coordinate system, and thus a global map 33 is generated.

Further, when the local maps M1 to M3 are combined, pieces of position information 33a-1 to 33a-3 of the respective client devices 32-1 to 32-3 possessed by the users 31-1 to 31-3 are registered on the global map 33.

The client devices 32-1 to 32-3 can superimpose and display common CG at a natural angle according to positional relationships between the client devices 32-1 to 32-3 and positions and postures thereof with reference to the global map 33.

More specifically, in each of the client devices 32-1 to 32-3, when a moving image of a real space is captured by a camera (not shown), an image capturing result is displayed on a display unit (not shown). Here, for example, there will be described a case of executing a common application program in which, when a specific subject existing in the real space is captured and displayed on the display unit, CG of a specific character is superimposed and displayed on the specific subject in an image as an AR image at a natural angle according to the positions and postures of the client devices 32-1 to 32-3.

In this case, each of the client devices 32-1 to 32-3 individually executes SLAM on the basis of a captured image, estimates a self-position, and generates a local map.

Then, the generated local maps are combined to generate and share a global map, and, when the specific subject appears in the image captured by the own client device, each of the client devices 32-1 to 32-3 superimposes and displays the CG of the specific character on the specific subject as an AR image at an angle according to the position and posture of the own client device based on the global map.

Therefore, for example, when the plurality of users 31-1 to 31-3 captures an image such that the specific subject in the common real space is within the angle of view during capturing of a moving image by using the respective client devices 32-1 to 32-3, the users can view an image in which the CG of the specific character is superimposed and displayed on the specific subject as an AR image at a natural angle according to the positions and postures of the users.

As a result, the plurality of users 31-1 to 31-3 can view the CG of the character superimposed and displayed as an AR image on the actually existing specific subject in the captured image at the position and posture of each user as if the character exists on the subject in the real space as a real image.

Further, the plurality of users 31-1 to 31-3 can view the CG of the character superimposed and displayed on the specific subject as an AR image at a natural angle according to not only the positions and postures thereof, but also the mutual positional relationships.

As a result, the plurality of users 31-1 to 31-3 can have an experience as if the users view CG of a common character as a real image in real time according to not only the positions and postures thereof, but also the mutual positional relationships.

When the global map 33 is generated once, processing of sequentially updating the global map on the basis of the local maps M1 to M3 supplied from the client devices 32-1 to 32-3 is repeated.

Here, processing of first supplying the local maps M1 to M3 from the client devices 32-1 to 32-3, combining the local maps to unify coordinate systems, and generating the global map 33 is SLAM initialization for generating a global map.

Note that processing in which the client devices 32-1 to 32-3 individually start SLAM and start generating the local maps M1 to M3 is SLAM initialization for generating a local map.

That is, the SLAM initialization includes the SLAM initialization for a local map and the SLAM initialization for a global map. However, the present disclosure is targeted to the initialization for a global map.

### <SLAM Initialization for Global Map (Part 1)>

There are several methods for implementing the SLAM initialization for generating a global map.

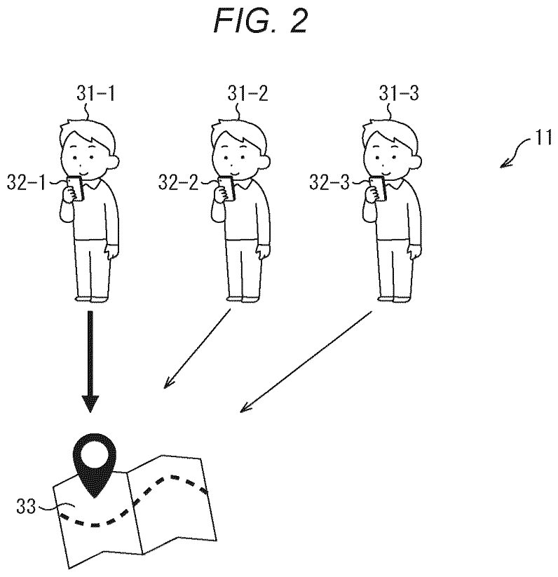

For example, as shown in FIG. 2, there is a method of generating the global map 33 by setting a coordinate system of the local map generated by any one of the client devices 32-1 to 32-3 as a reference coordinate system and adding information of another local map.

That is, in FIG. 2, the global map 33 is generated by adding information of the local maps M2 and M3 generated by the client devices 32-2 and 32-3 to the local map M1 generated by the client device 32-1 while setting a coordinate system of the local map M1 as reference coordinates.

In this case, it is unnecessary to combine the local maps, and thus the processing becomes simple. However, it is necessary to determine which one of the local maps of the client devices 32 is set as a reference, and all the local maps need to include the same reference coordinates. Therefore, all the client devices 32-1 to 32-3 need to use an image having a common field of view, and thus there are many restrictions on user experience (UX).

### <SLAM Initialization for Global Map (Part 2)>

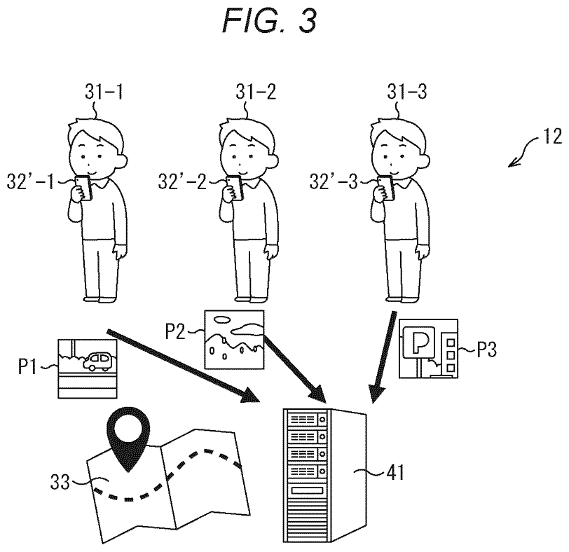

Further, as shown in FIG. 3, the client devices 32-1 to 32-3 transmit images P1 to P3 necessary to implement SLAM for generating a local map to a server 41.

The server 41 constructs the global map 33 by using a technology called structure-from-motion (SfM: 3D reconstruction) on the basis of the images P1 to P3 transmitted from the client devices 32-1 to 32-3.

In the case of FIG. 3, as compared with the SLAM initialization for a global map described with reference to FIG. 2, there is no restriction on the UX, but, because the client devices 32-1 to 32-3 transmit the images to the server 41, an amount of transmission data is large, and a processing load on the server 41 is large.

### <SLAM Initialization for Global Map of Present Disclosure>

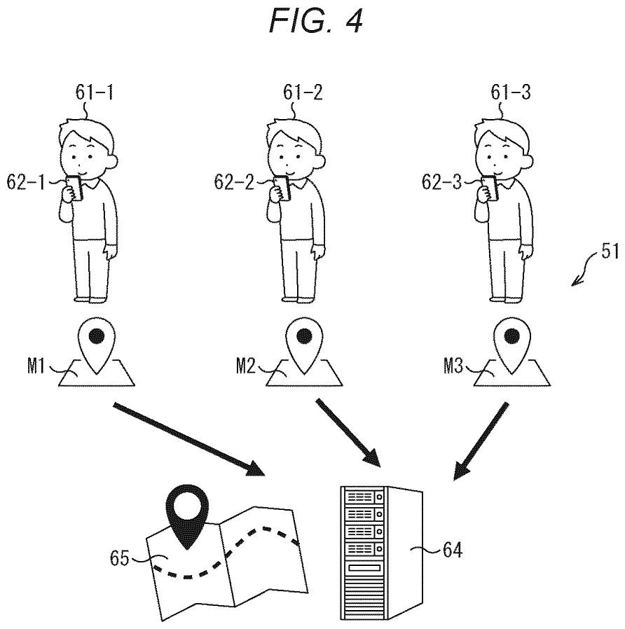

Therefore, the SLAM initialization for a global map of the present disclosure is implemented by a configuration shown in a communication system 51 of FIG. 4.

That is, in the communication system 51 of FIG. 4, client devices 62-1 to 62-3 possessed by respective users 61-1 to 61-3 generate respective local maps M1 to M3 by SLAM and transmit the generated local maps to a server 64.

When acquiring the local maps M1 to M3 transmitted from the respective client devices 62-1 to 62-3, the server 64 unifies coordinate systems thereof to a reference coordinate system and combines the local maps M1 to M3, thereby generating a global map 65.

With such a configuration, in the communication system 51 of the present disclosure, there is no restriction on the UX, and information transmitted to the server 64 is the local maps M1 to M3, and the amount of transmission data can be reduced as compared with the images P1 to P3, and the processing load on the server 64 can also be reduced.

Further, the server 64 generates the global map by combining common parts of the plurality of local maps such that the common parts overlap with each other.

However, the global map cannot be constructed for various reasons, for example, because a common part in all the plurality of local maps does not exist and not all the local maps can be combined, or because there is no sufficient motion parallax and the SLAM for a local map fails. Thus, the SLAM initialization for a global map fails in some cases.

Heretofore, when the SLAM initialization for a global map fails, the user can recognize that the SLAM initialization for a global map has failed, but cannot recognize what is the cause or recognize what to do to successfully perform the SLAM initialization.

In view of this, in the present disclosure, the server 64 presents a countermeasure to the failure of the SLAM initialization for a global map to the user 61 via the client device 62 according to the cause of the failure and leads the user to successfully perform the SLAM initialization for a global map.

For example, in a case where the SLAM initialization for a global map fails because a common part in all the plurality of local maps does not exists and not all the local maps can be combined, it is possible to implement the SLAM initialization for a global map by constructing a common part in the local maps to be combined.

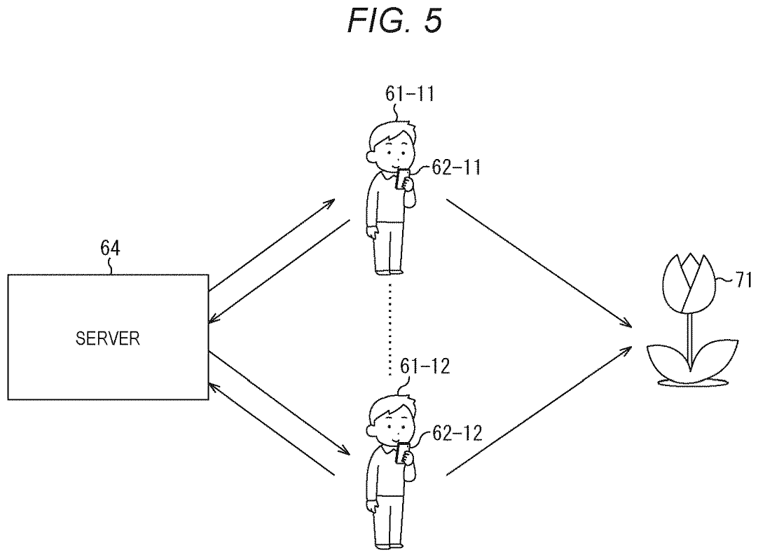

More specifically, there will be described a case where the SLAM initialization for a global map fails in client devices 62-11 and 62-12 possessed by both users 61-11 and 61-12 as shown in FIG. 5 because a common part in both the local maps does not exist.

In such a case, the server 64 supplies guide information for successfully performing the SLAM initialization for a global map to the client devices 62-11 and 62-12 so as to encourage an action to construct a common part in both the local maps and presents the guide information on each of the client devices 62-11 and 62-12.

For example, the server 64 supplies guide information for encouraging both the users 61-11 and 61-12 to capture an image of a common subject 71 to the client devices 62-11 and 62-12 so as to generate a common part in the local maps and presents the guide information to the users 61-11 and 61-12.

When the users 61-11 and 61-12 capture an image of the common subject 71 by using the client devices 62-11 and 62-12 on the basis of the presentation of the guide information, a common part is generated in both the local maps, and thus both the local maps can be combined. As a result, the SLAM initialization for a global map can be successfully performed.

As described above, in the present disclosure, in a case where the SLAM initialization for a global map fails, the server 64 presents guide information as a countermeasure to the cause of the failure to the user 61 via the client device 62 and leads the user 61 to solve the cause of the failure, thereby successfully performing the SLAM initialization for a global map.

Therefore, the user can easily solve the failure of the SLAM initialization for a global map by himself/herself. This makes it easy to use an application program to which XR technology is applied in a plurality of client devices.

### <Configuration Example of Communication System of Present Disclosure>

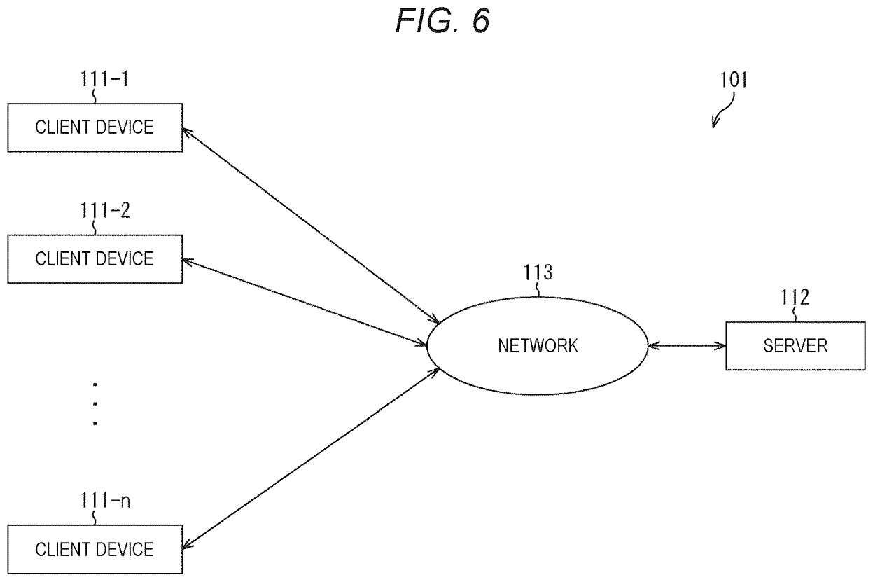

Next, a configuration example of a communication system of the present disclosure will be described with reference to FIG. 6.

A communication system 101 of FIG. 6 includes client devices 111-1 to 111-n, a server 112, and a network 113.

The client devices 111-1 to 111-n and the server 112 can exchange data and programs with each other via the network 113 including the Internet, a public line, and the like.

The client devices 111-1 to 111-n are so-called smartphones, tablets, or the like possessed by users.

Note that, hereinafter, in a case where it is unnecessary to distinguish the client devices 111-1 to 111-n in particular, the client devices will be simply referred to as the client devices 111, and other configurations will also be referred to in a similar manner.

Further, it is assumed that the users of the client devices 111-1 to 111-n exist in a common space (either a real space or a virtual space) in which the users can recognize mutual positional relationships. That is, for example, in the real space, it is assumed that the plurality of users exists in a mutually visible positional relationship.

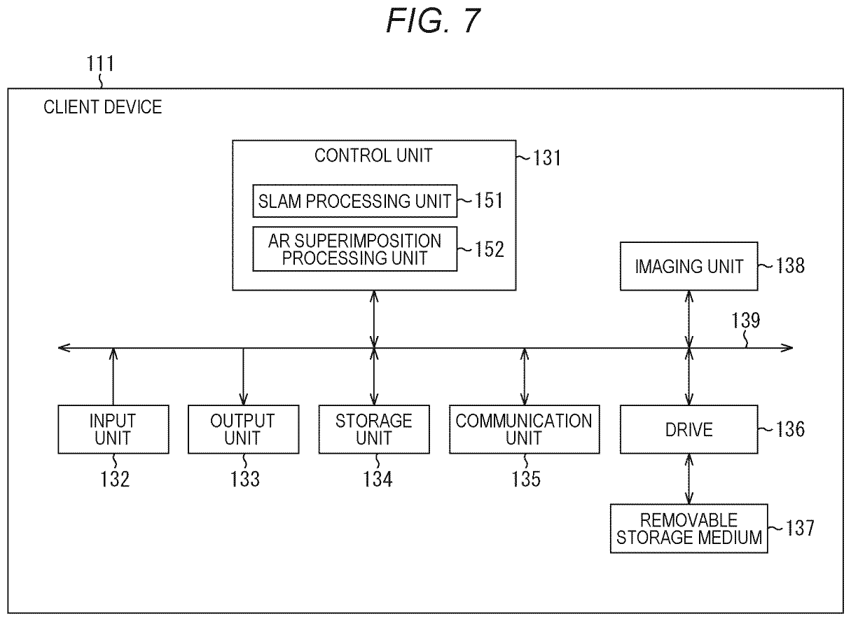

The client device 111 includes an imaging unit 138 (FIG. 7), captures an image, executes SLAM when, for example, various application programs using XR technology are executed on the basis of the captured image, implements self-localization (estimation of position and posture) on the basis of a positional relationship with the surroundings, and generates a local map having a coordinate system of the own client device on the basis of the obtained position and posture.

The client device 111 transmits the generated local map to the server 112 and acquires information of the position and posture based on a global map generated by combining local maps from the other client devices 111 in a coordinate system serving as a unified reference.

The client device 111 superimposes and displays various images on the basis of the acquired information of the position and posture based on the global map in an application program using an XR function.

For example, in a case where an application program that operates by applying AR technology is executed, the client device 111 superimposes and displays an AR image on the basis of the acquired information of the position and posture based on the global map.

Therefore, each of the client devices 111-1 to 111-n displays the AR image on the basis of its own position and posture on the global map constructed in the unified reference coordinate system, and thus each of the users of the client devices 111-1 to 111-n can view the AR image according to the position and posture with respect to other users.

As a result, the users of the client devices 111-1 to 111-n can view an XR image superimposed at a natural angle on the basis of the positions and postures thereof on the global map constructed in the reference coordinate system and thus can have a common experience in real time.

The server 112 is managed by an organization that operates the application program using XR technology executed by the client devices 111-1 to 111-n on the network 113 and is implemented by, for example, a single server computer or cloud computing.

When the application program using XR technology is executed in the client devices 111-1 to 111-n, the server 112 acquires the local maps transmitted from the client devices 111-1 to 111-n, combines the local maps to generate a global map having a unified reference coordinate system, and transmits information of the positions and postures of the client devices 111-1 to 111-n based on the generated global map to the client devices.

Further, in a case where the local maps cannot be combined with some cause at the time of combining the local maps, the server 112 specifies the type of the cause, generates guide information for leading to solving the failure of the combination according to the type of the cause, and transmits the guide information to the client device 111.

When acquiring the guide information for leading to solving the failure of the combination of the local maps transmitted from the server 112, the client device 111 presents the guide information to the user.

Therefore, the user can recognize that the combination of the local maps has failed and a global map cannot be acquired and can also recognize how to solve the failure of the combination of the local maps and acquire a global map.

As a result, the user can solve a situation where the combination of the local maps fails by himself/herself. This allows the user to use the application program using XR technology comfortably and easily.

### <Configuration Example of Client Device>

Next, a configuration example of the client device 111 will be described with reference to FIG. 7.

The client device 111 includes a control unit 131, an input unit 132, an output unit 133, a storage unit 134, a communication unit 135, a drive 136, a removable storage medium 137, and an imaging unit 138, which are connected to each other via a bus 139, and can transmit and receive data and programs.

The control unit 131 includes a processor and a memory and controls the entire operation of the client device 111. Further, the control unit 131 includes an SLAM processing unit 151 and an AR superimposition processing unit 152.

The SLAM processing unit 151 executes SLAM on the basis of an image captured by the imaging unit 138, generates a local map of its own coordinate system on the basis of a self-localization result that is a processing result of SLAM, and stores the local map in the storage unit 134.

The SLAM processing unit 151 controls the communication unit 135 to transmit the local map stored in the storage unit 134 to the server 112.

The SLAM processing unit 151 controls the communication unit 135 to acquire information of a position and posture based on a global map transmitted from the server 112 and stores the information in the storage unit 134.

After acquiring the information of the position and posture based on the global map, the SLAM processing unit 151 executes processing on the basis of the acquired information of the position and posture based on the global map when executing various application programs using various XR technologies.

The SLAM processing unit 151 acquires guide information for leading to solving a failure of combination of local maps according to the type of cause of the failure, the guide information being transmitted from the server 112 when the combination of the local maps fails, and displays the guide information on a display or the like included in the output unit 133.

When an application program achieved by using AR technology is executed, the AR superimposition processing unit 152 processes an AR image into a natural angle on the basis of the local map stored in the storage unit 134 or the information of the position and posture based on the global map supplied from the server 112 and superimposes and displays the AR image.

Note that an example where, among XR technologies, an application program for displaying an AR image is executed in the client device 111 of FIG. 7 will be described. However, another XR technology may be used, and similarly, an XR image may be superimposed and displayed on the basis of the local maps or the information of the position and posture based on the global map.

The input unit 132 includes input devices such as a keyboard, mouse, and touchscreen with which an operation command is input and a microphone with which voice is input and supplies various input signals to the control unit 131.

The output unit 133 is controlled by the control unit 131 and includes a display unit and a voice output unit. The output unit 133 outputs an operation screen and an image of a processing result to the display unit including a display device configured by a liquid crystal display (LCD), an organic electro luminescence (EL), or the like and displays the operation screen and the image of the processing result. Further, the output unit 133 controls the voice output unit including a voice output device to output various voices.

The storage unit 134 includes a hard disk drive (HDD), a solid state drive (SSD), a semiconductor memory, or the like and is controlled by the control unit 131 to write or read various types of data including content data and programs.

The communication unit 135 is controlled by the control unit 131, implements communication represented by a local area network (LAN), Bluetooth (registered trademark), or the like in a wired or wireless manner, and transmits and receives various types of data and programs to and from various devices via the network 113 as necessary.

The drive 136 reads and writes data from and to the removable storage medium 137 such as a magnetic disk (including a flexible disk), an optical disk (including a compact disc-read only memory (CD-ROM) and a digital versatile disc (DVD)), a magneto-optical disk (including a mini disc (MD)), or a semiconductor memory.

The imaging unit 138 includes a complementary metal oxide semiconductor (CMOS) image sensor or the like and is controlled by the control unit 131 to capture an image.

### <Configuration Example of Server>

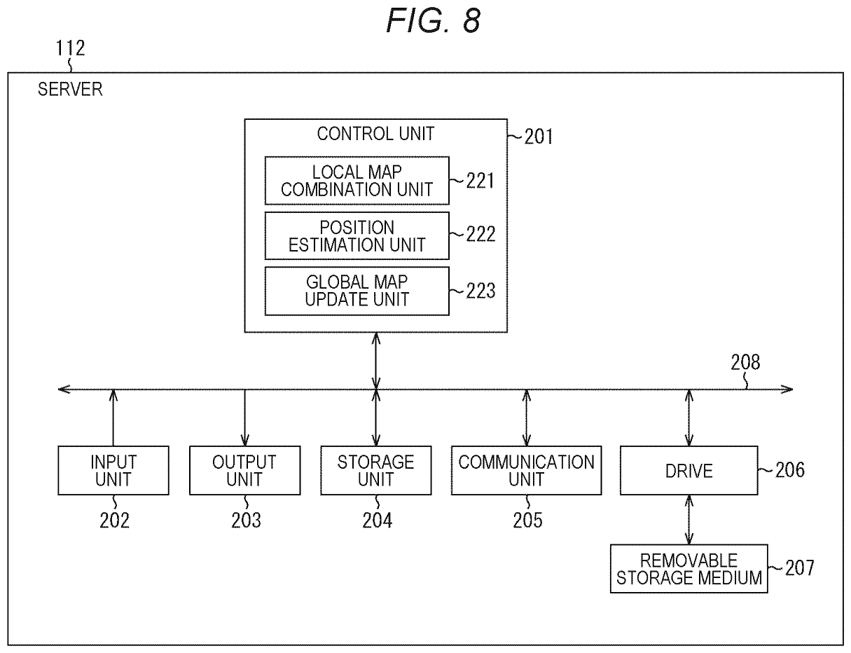

Next, a configuration example of the server 112 will be described with reference to FIG. 8.

The server 112 includes a control unit 201, an input unit 202, an output unit 203, a storage unit 204, a communication unit 205, a drive 206, and a removable storage medium 207, which are connected to each other via a bus 208, and can transmit and receive data and programs.

The control unit 201 includes a processor and a memory and controls the entire operation of the server 112. Further, the control unit 201 includes a local map combination unit 221, a position estimation unit 222, and a global map update unit 223.

As the SLAM initialization processing for a global map, the local map combination unit 221 combines local maps having respective coordinate systems supplied from the plurality of client devices 111 and generates a global map having a unified reference coordinate system (global coordinate system).

In a case where the local maps cannot be combined with some cause at the time of combining the local maps, the local map combination unit 221 specifies the type of the cause, generates guide information for leading to solving the failure of the combination according to the type of the cause, and transmits the guide information to the client device 111.

After the local maps are combined and the global map is generated as the SLAM initialization processing for a global map, the position estimation unit 222 estimates positions and postures of the client devices 111 based on the global map on the basis of the information of the positions and postures in the local maps transmitted from the client devices 111.

The global map update unit 223 sequentially updates the global map on the basis of the local maps transmitted from the client devices 111 and continues the update according to a change in environment.

Note that the input unit 202, the output unit 203, the storage unit 204, the communication unit 205, the drive 206, and the removable storage medium 207 have configurations basically similar to the input unit 132, the output unit 133, the storage unit 134, the communication unit 135, the drive 136, and the removable storage medium 137 in FIG. 7, and thus description thereof is omitted.

### <Data Structure Forming Local Map and Global Map>

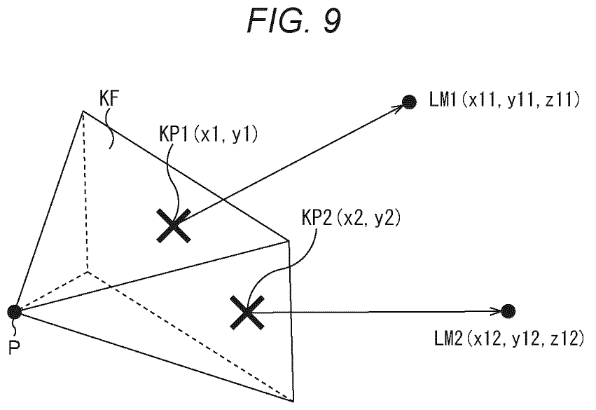

Next, data structures forming a local map and a global map will be described with reference to FIG. 9.

The local map and the global map are an aggregate of a plurality of pieces of information extracted from an image called key frame which is selected on the basis of a predetermined selection reference from among images captured by the imaging unit 138.

More specifically, the local map and the global map include a key point that is a feature point in the image extracted from the key frame, a feature value thereof, two-dimensional coordinates of the feature point in the image, coordinates in a three-dimensional space (three-dimensional coordinates) of a landmark that is a subject at the feature point, and a position and posture of the imaging unit 138 at the time of capturing the image serving as a key frame.

For example, a key frame KF in FIG. 9 includes feature values of key points KP1 and KP2 serving as feature points, coordinates KP1(x1, y1) and KP2(x2, y2) thereof, coordinates LM1(x11, y11, z11) and LM2 (x12, y12, z12) of landmarks thereof, and a position and posture P of the imaging unit 138 at the time of capturing the key frame KF. Note that, here, the position and posture are collectively denoted by one reference sign “P”.

That is, the SLAM processing unit 151 selects the key frame KF on the basis of the predetermined selection reference from the images consecutively captured by the imaging unit 138, determines key points serving as feature points from the key frame KF on the basis of texture, and extracts feature values.

The SLAM processing unit 151 specifies two-dimensional coordinates of the key points in the key frame KF and specifies three-dimensional coordinates of a landmark for each key point by using motion parallax.

The SLAM processing unit 151 uses pair information of the two-dimensional coordinates of each of the plurality of key points and the three-dimensional coordinates of the corresponding landmark to calculate the position and posture of the imaging unit 138 at the time of capturing the key frame KF, that is, substantially the position and posture of the client device 111.

It is known that, when pair information of two-dimensional coordinates of three or more key points and three-dimensional coordinates of the corresponding landmarks is acquired, the posture of the imaging unit 138 can be estimated by an algorithm using a Perspective-n-Point (PnP) estimation method.

Note that, for the posture estimation by the PnP estimation method, it is necessary to avoid an influence of an error and a state in which three points exist on the same plane, and thus a PnP-random sample consensus (RANSAC) method combined with a method called RANSAC estimation method is generally used.

The RANSAC estimation method is an estimation method of, when a posture estimated by the PnP estimation method is used for n pairs of points to project other pieces of pair information on an image, counting the number of the pieces of pair information sufficiently close to a key point (inlier number) and adopting a posture having the maximum inlier number when the pair information of the n points used for posture estimation by the PnP estimation method is randomly changed.

Note that the posture estimation of the imaging unit 138 is accurately implemented by using a hundred or more pairs uniformly distributed in the entire key frame KF.

The SLAM processing unit 151 connects a plurality of key frames KF obtained in this manner with a common landmark, thereby estimating a self-position and mapping the surroundings.

### <Principle of Generating Local Map by SLAM>

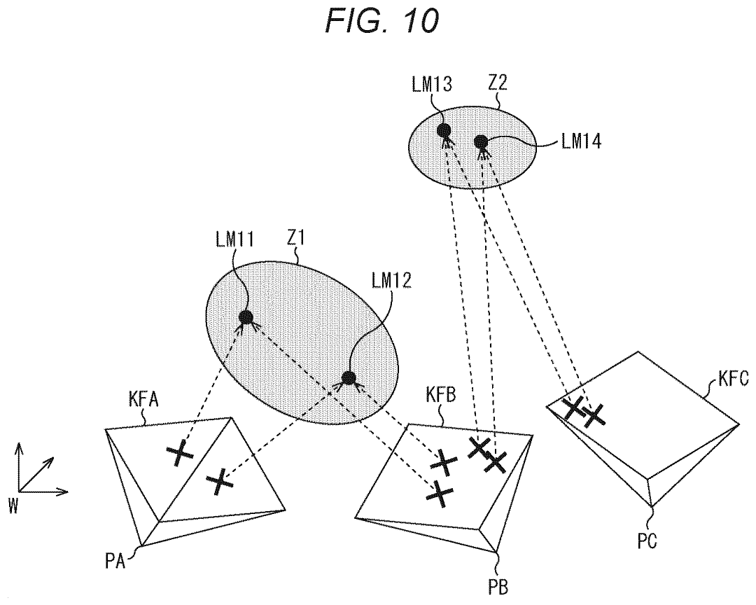

Next, a principle of generating a local map by SLAM will be described. Here, for example, key frames KFA, KFB, and KFC shown in FIG. 10 consecutively exist in time series.

Here, in FIG. 10, the key frame KFA includes landmarks L11 and L12 in a coordinate system W of the client device 111, the key frame KFB includes landmarks L11 to L14 in the coordinate system W of the client device 111, and the key frame KFC includes the landmarks L13 and L14 in the coordinate system W of the client device 111.

As shown in FIG. 10, the key frames KFA and KFB include the common landmarks LM11 and LM12 in a region Z1 to be a common field of view.

Therefore, in a case where a position and posture PA of the key frame KFA are known, the SLAM processing unit 151 estimates a position and posture PB of the key frame KFB on the basis of the common landmarks LM11 and LM12 and the position and posture PA of the key frame KFA.

Further, in FIG. 10, the key frames KFB and KFC include the common landmarks LM13 and LM14 in a region Z2 to be a common field of view.

Therefore, because the position and posture PB of the key frame KFB are known as described above, the SLAM processing unit 151 specifies a position and posture PC of the key frame KFC on the basis of the common landmarks LM13 and LM14 and the position and posture PB of the key frame KFB.

In this manner, the SLAM processing unit 151 estimates time-series positions and postures PA, PB, and PC of the imaging unit 138 on the basis of information of the consecutive key frames KFA, KFB, and KFC.

Further, similarly, the SLAM processing unit 151 maps the surroundings of the imaging unit 138 by using the landmarks L11 to L14 on the basis of the information of the consecutive key frames KFA, KFB, and KFC.

By executing SLAM, the SLAM processing unit 151 estimates the position and posture of the imaging unit 138 on the basis of an aggregate of the plurality of key frames and maps the surroundings in this manner, thereby forming a local map.

Note that, here, a map including an estimation result of the position and posture of the imaging unit 138 reproduced on the basis of the aggregate of the plurality of key frames and a mapping result of the surroundings is referred to as a local map. However, the aggregate of the plurality of key frames is substantially a data structure of a local map, and thus, hereinafter, the aggregate of the plurality of key frames itself will also be simply referred to as a local map.

Further, a global map is also an aggregate of a plurality of key frames, but is different in that, in the local map, a coordinate system of each key frame is an individual coordinate system of the client device 111, whereas the global map is formed in a reference coordinate system common to the plurality of client devices 111.

### <Combination of Local Maps>

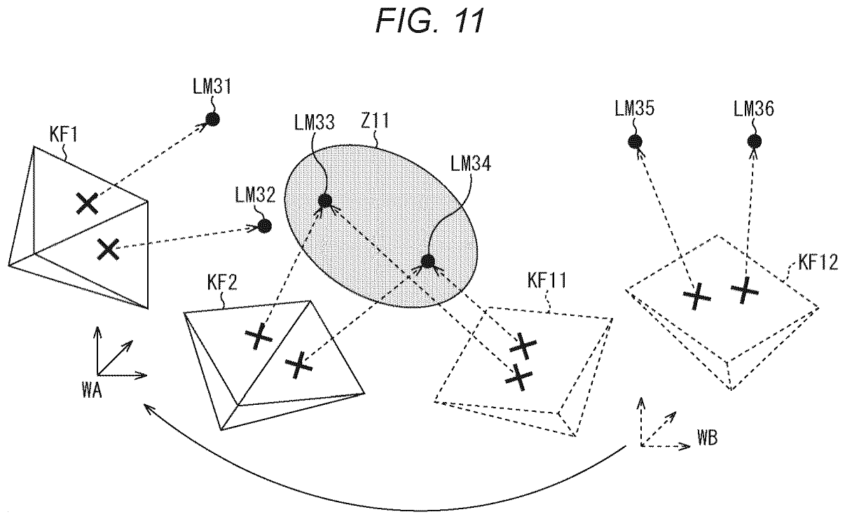

Next, combination of local maps will be described with reference to FIG. 11.

For example, as shown in FIG. 11, a case of combining a local map A including key frames KF1 and KF2 indicated by solid lines and a local map B including key frames KF11 and KF12 indicated by dotted lines will be described.

Here, in the local map A, the key frame KF1 includes landmarks LM31 and LM32 in a coordinate system WA, and the key frame KF2 includes landmarks LM33 and LM34 in the coordinate system WA.

Further, in the local map B, the key frame KF11 includes the landmarks LM33 and LM34 in a coordinate system WB, and the key frame KF12 includes landmarks LM35 and LM36 in the coordinate system WB.

At this time, in a region Z11 to be a common field of view, the key frame KF2 of the local map A and the key frame KF11 of the local map B include the common landmarks LM33 and LM34.

Therefore, for example, in a case where the coordinate system WA is set as a reference coordinate system in a global map, the local map combination unit 221 converts the position and posture of the imaging unit 138 in the coordinate system WB in the key frame KF11 into the position and posture of the imaging unit 138 in the coordinate system WA and converts three-dimensional coordinates of the landmarks LM33 and LM34 in the coordinate system WB into the three-dimensional coordinates of the landmarks LM33 and LM34 in the coordinate system WA on the basis of a correspondence relationship between the three-dimensional coordinates of the landmarks LM33 and LM34 in the coordinate system WB and the three-dimensional coordinates of the landmarks LM33 and LM34 in the coordinate system WA.

At this time, the local map combination unit 221 also converts the position and posture of the imaging unit 138 in the coordinate system WB in the key frame KF12 into the position and posture of the imaging unit 138 in the coordinate system WA and converts three-dimensional coordinates of the landmarks LM35 and LM36 in the coordinate system WB into the three-dimensional coordinates of the landmarks LM35 and LM36 in the coordinate system WA on the basis of the correspondence relationship between the three-dimensional coordinates of the landmarks LM33 and LM34 in the coordinate system WB and the three-dimensional coordinates of the landmarks LM33 and LM34 in the coordinate system WA.

By such processing, the three-dimensional coordinates of the landmarks of the key frames KF1, KF2, KF11, and KF12 and the position and posture of the imaging unit 138 in each key frame are all in the common reference coordinate system WA to make a common coordinate system, and the local maps A and B are combined to generate a global map including the key frames KF1, KF2, KF11, and KF12. Thus, the SLAM initialization for a global map is implemented.

### <Cause and Solution of Failure of SLAM Initialization for Global Map>

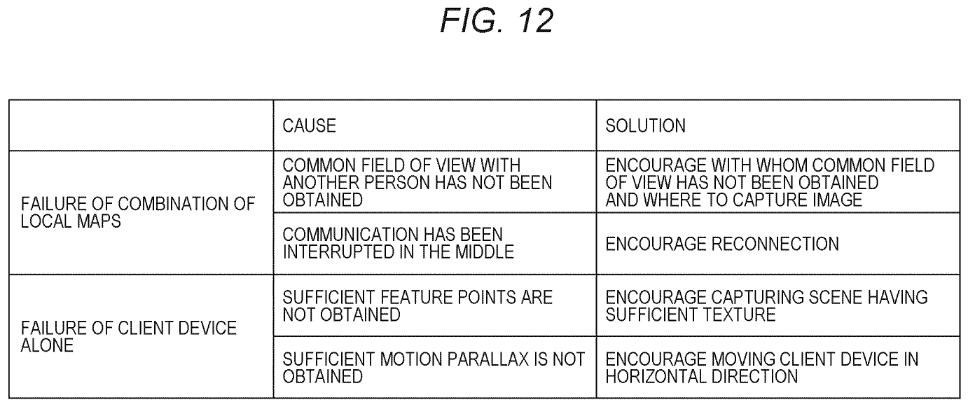

Next, the cause and solution of a failure of the SLAM initialization for a global map will be described with reference to FIG. 12.

### <Case of Failure Due to not Obtaining Common Field of View>

Failures of the SLAM initialization for a global map are roughly divided into two cases. A first case is a case where combination of local maps fails, and a second case is a case where the client device 111 alone fails.

Examples of the case where combination of local maps fails include a case where the combination fails because a common field of view with another person is not obtained and a case where the combination fails because communication is interrupted in the middle.

The case where a common field of view with another person is not obtained is, for example, a failure caused by the following fact: the region Z11 to be a common field of view described with reference to FIG. 11 is not obtained, and there is no key frame including the same landmark used to convert a coordinate system, and thus the coordinate system cannot be converted.

Therefore, in this case, a solution is to encourage with whom the common field of view has not been obtained and where to capture an image to form the common field of view, thereby solving the failure of the combination of the local maps.

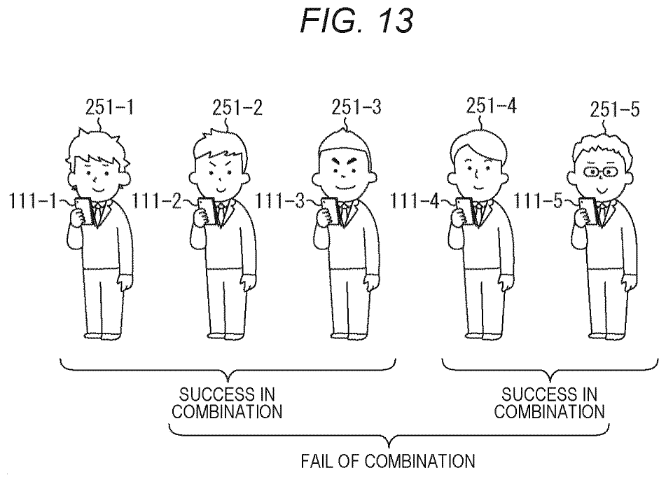

For example, as shown in FIG. 13, there will be described a case where users 251-1 to 251-5 possess respective client devices 111-1 to 111-5, and local maps are successfully combined in a group including the client devices 111-1 to 111-3 and in a group including the client devices 111-4 and 111-5, but the local maps are not combined between the groups, and as a result, the combination fails.

In such a case, when an image is captured such that any imaging field of view belonging to the group of the client devices 111-1 to 111-3 is the same as any imaging field of view belonging to the group of the client devices 111-4 and 111-5, it is possible to secure the common field of view. Thus, the local maps are combined between the groups, and the failure of the combination is solved.

Alternatively, when an image is captured such that any imaging field of view in the group of the client devices 111-4 and 111-5 is the same as any imaging field of view in the group of the client devices 111-1 to 111-3, it is possible to secure the common field of view. Thus, the local maps are combined between the groups, and the failure of the combination is solved.

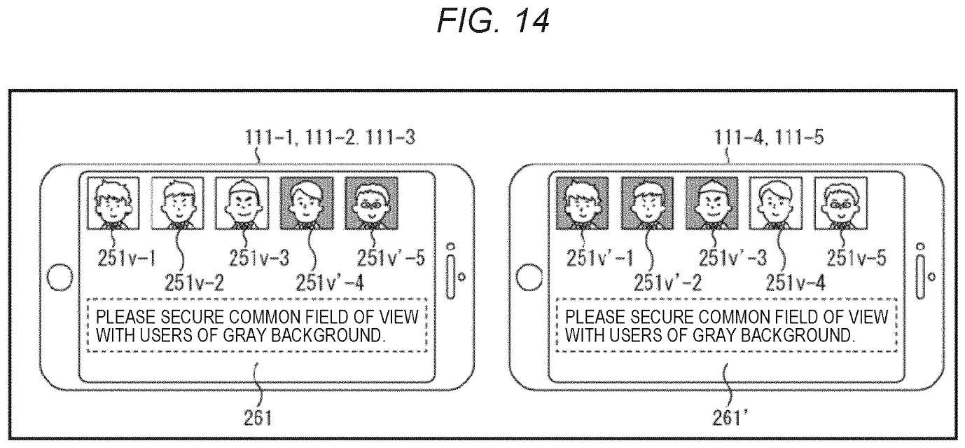

Therefore, for example, guide information 261 and 261′ shown in FIG. 14 is presented.

That is, both the pieces of the guide information 261 and 261′ indicate that the local maps have been successfully combined in the group of the client devices 111-1 to 111-3 and in the group of the client devices 111-4 and 111-5, but the combination between the groups has failed.

Further, in FIG. 14, “Please secure common field of view with users with gray background” is also displayed.

More specifically, a left part of FIG. 14 is a display example of the guide information 261 presented in each of the client devices 111-1 to 111-3, and icons 251v-1 to 255v-3 and icons 255v′-4 and 255v′-5 corresponding to the users 251-1 to 255-5 are displayed.

In the guide information 261, the icons 251v-1 to 255v-3 of the users belonging to the group of the client devices 111-1 to 111-3 in which the local maps to which the own client devices 111 belong have been successfully combined are displayed with white background, and the icons 251v′-4 and 255v′-5 corresponding to the users to which the own client devices 111 do not belong and who have failed to combine the local maps with the own group are displayed with gray background.

With such guide information 261, the users 251-1 to 251-3 of the client devices 111-1 to 111-3 can recognize that the users belong to the group of the client devices 111-1 to 111-3, and the local maps have been successfully combined, but combination of the local maps with the group of the client devices 111-4 and 111-5 has failed.

Similarly, a right part of FIG. 14 is a display example of the guide information 261′ presented in each of the client devices 111-4 and 111-5, and icons 251v′-1 to 255v′-3 and icons 255v-4 and 255v-5 corresponding to the users 251-1 to 255-5 are displayed.

Further, in the guide information 261′, the icons 251v-4 and 255v-5 of the users belonging to the group of the client devices 111-4 and 111-5 in which the local maps to which the own client devices 111 belong have been successfully combined are displayed with white background, and the icons 251v′-1 to 255v′-3 corresponding to the users to which the own client devices 111 do not belong and who have failed to combine the local maps with the own group are displayed with gray background.

With such guide information 261′, the users 251-4 and 251-5 of the client device 111-4 and 111-5 can recognize that the users belong to the group of the client device 111-4 and 111-5, and the local maps have been successfully combined, but combination of the local maps with the group of the client devices 111-1 to 111-3 has failed.

As a result, the users 251-1 to 251-5 of the respective client devices 111-1 to 111-5 can recognize that the users can easily solve the failure of the combination of the local maps by capturing an image of the common field of view with the client devices 111 of the users 251 who have failed to combine the local maps.

Note that FIG. 14 shows an example of the guide information 261 and 261′ in a case where the number of groups of the client devices 111 whose local maps have been successfully combined is two. However, more groups may be presented, and in that case, although the backgrounds of the respective icons 251v and 251v′ are colored with white or gray, but the backgrounds may be distinguished by more colors. Further, FIG. 14 shows an example where success and failure of the combination of the local maps are expressed by a background color of another user expressed as an icon. However, as long as success or failure of the combination of the local maps can be expressed, the combination may be expressed by a method other than the example of FIG. 14. For example, a list of users who have failed to combine the local maps may be displayed for each user. At this time, a list of users who have successfully combined the local maps may also be displayed.

<Case where Communication is Interrupted in the Middle>

Further, in a case where communication is interrupted in the middle, local maps cannot be appropriately acquired, and thus combination of the local maps fails. In such a case, it is necessary to encourage reconnection of the communication.

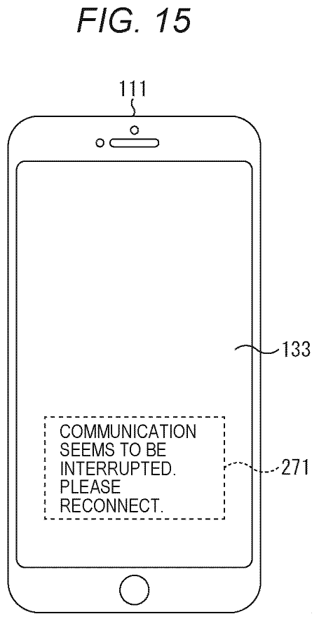

For example, as shown in FIG. 15, guide information 271 for encouraging reconnection, such as “Communication seems to be interrupted. Please reconnect.”, is presented.

<Case where Sufficient Feature Points are not Obtained>

Examples of the case where the client device 111 alone fails include a case where the combination fails due to not obtaining sufficient feature points and a case where the combination fails due to not obtaining sufficient motion parallax.

The case where sufficient feature points are not obtained is, for example, a state in which feature points are not obtained because texture is insufficient in a captured image.

In such a case, it is possible to cause the user to recognize that the failure of the combination may be solved by displaying guide information for encouraging capturing a scene having sufficient texture to easily obtain feature points from the texture.

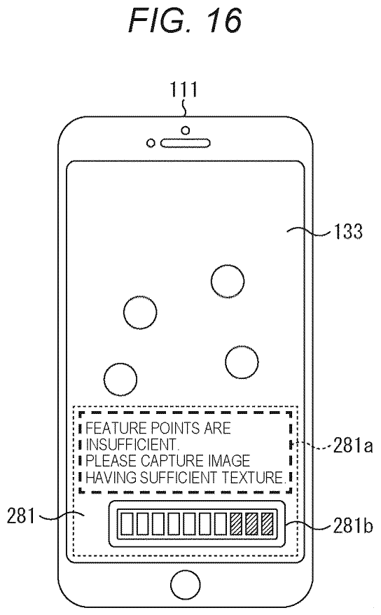

For example, as shown in FIG. 16, the necessity of capturing a scene having sufficient texture may be presented, and how many feature points are necessary may also be presented to encourage capturing a scene having sufficient texture by showing guide information 281 including a comment guide 281a such as “Feature points are insufficient. Please capture image having sufficient texture.” and a feature point gauge 281b.

Regarding the number of key points serving as feature points (the number of pieces of pair information which is the number of pieces of pair information of information of the two-dimensional coordinates and information of the three-dimensional coordinates of the corresponding landmark), the feature point gauge 281b in FIG. 16 expresses a ratio of the number of currently detected key points to the minimum number of key points required for the SLAM processing by using the number of white squares with respect to the total number of squares.

In the feature point gauge 281b of FIG. 16, the total number of squares is ten, and seven squares are displayed in white. Therefore, only 70% of the number of key points is obtained with respect to the minimum number of key points required as the number of key points serving as the feature points. This indicates that the combination of the local maps has failed.

When the guide information 281 including the comment guide 281a such as “Feature points are insufficient. Please capture image having sufficient texture.” and the feature point gauge 281b is displayed, it is possible to encourage capturing a scene having sufficient texture.

Further, when the feature point gauge 281b is displayed, the user can recognize that the failure of the combination of the local maps may be solved by capturing a scene having sufficient texture.

Furthermore, the user can recognize how many key points are insufficient while viewing the overall ratio indicated by white squares in the feature point gauge 281b.

Note that, although the example where the feature point gauge 281b is displayed only with the number of key points serving as the feature points has been described above, the number of key points serving as the feature points and the entire distribution thereof may also be considered.

For example, an image forming a key frame may be divided into blocks of a fixed size, the number of blocks satisfying a condition that the number of key points serving as feature points in units of blocks is larger than the minimum required number of key points may be counted, and a ratio of the blocks to the minimum number of blocks satisfying the condition and required for the SLAM processing may be expressed by the number of white squares with respect to the total number of squares.

In this manner, the user can recognize how many pieces of pair information are required in consideration of the number of pieces of pair information of the information of the two-dimensional coordinates of the key point serving as the feature point and the information of the three-dimensional coordinates of the corresponding landmark and a distribution of regions satisfying information of the number of pieces of the pair information in the entire image forming the key frame.

<Case where Sufficient Motion Parallax is not Obtained>

In a case where sufficient motion parallax is not obtained, the three-dimensional coordinates of the landmark with respect to the key point cannot be obtained, and combination of the local maps fails.

In such a case, the failure can be solved by moving the client device 111 in a horizontal direction to forcibly encourage generating the motion parallax.

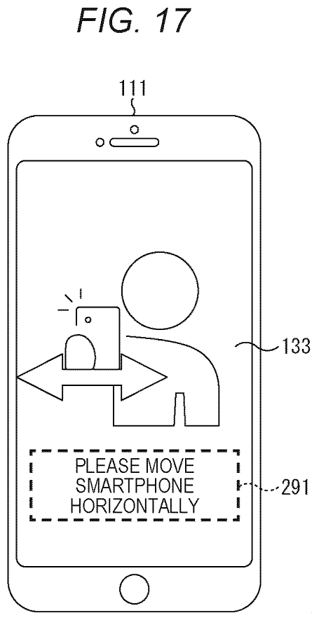

Therefore, for example, as shown in FIG. 17, guide information 291 indicating “Please move smartphone horizontally” may be displayed together with a display image of a person moving a smartphone that is the client device 111 in the horizontal direction.

With the guide information 291 in FIG. 17, the user can recognize that the combination of the local maps has failed due to not obtaining sufficient motion parallax and can also recognize that the failure may be solved by moving the client device 111 in the horizontal direction.

### <SLAM Initialization Processing for Global Map>

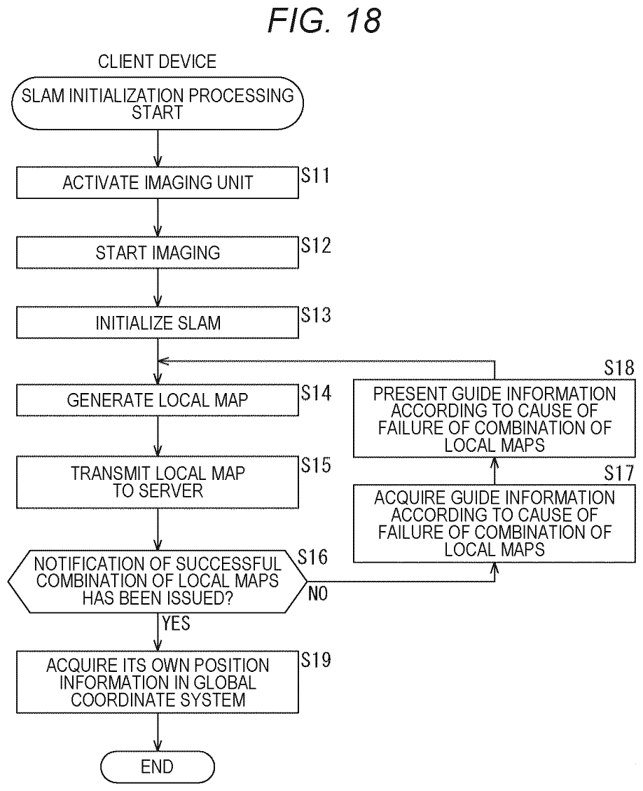

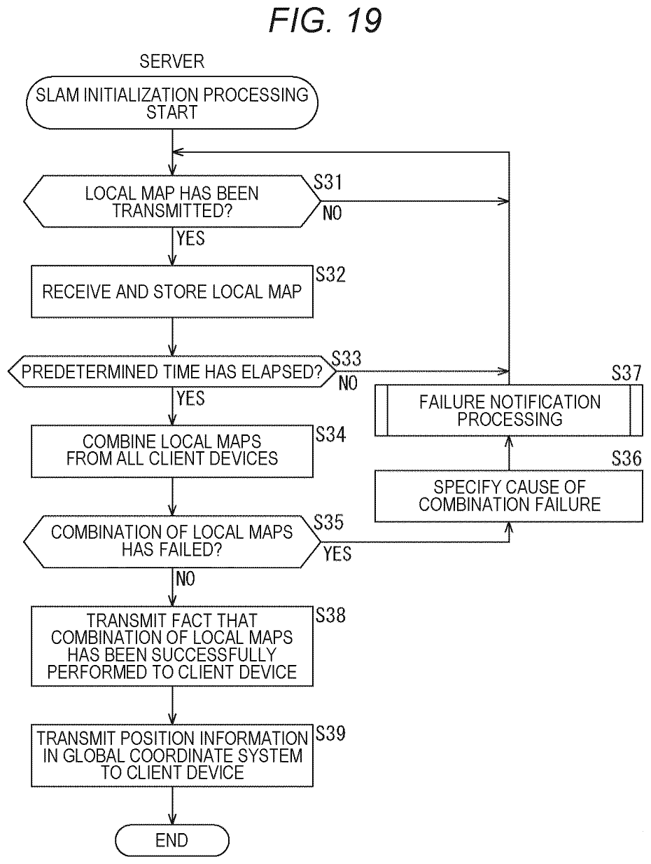

Next, the SLAM initialization processing for a global map by the client device 111 and the server 12 will be described with reference to flowcharts of FIGS. 18 and 19.

Note that FIG. 18 is a flowchart showing processing of the client device 111, and FIG. 19 is a flowchart showing processing of the server 112.

In step S11, the SLAM processing unit 151 activates the imaging unit 138.

In step S12, the SLAM processing unit 151 controls the imaging unit 138 to start capturing of an image and sequentially supply image capturing results.

In step S13, the SLAM processing unit 151 initializes SLAM for a local map.

In step S14, the SLAM processing unit 151 executes SLAM and extracts a key frame on the basis of the captured images.

The SLAM processing unit 151 extracts a feature point as a key point to specify two-dimensional coordinates, calculates a feature value, calculates three-dimensional coordinates of a landmark corresponding to the key point on the basis of motion parallax, and detects pair information of the two-dimensional coordinates of the key point and the three-dimensional coordinates of the landmark. Then, the SLAM processing unit 151 generates a local map as an aggregate of key frames and stores the local map in the storage unit 134.

In step S15, the SLAM processing unit 151 controls the communication unit 135 to transmit the local map stored in the storage unit 134 together with information for identifying itself to the server 112 via the network 113.

In step S31 (FIG. 19), the local map combination unit 221 of the server 112 controls the communication unit 205 to determine whether or not a local map has been transmitted from any of the client devices 111 via the network 113 and repeats similar processing until a local map is transmitted.

In step S31, when a local map is transmitted from the client device 111, the processing proceeds to step S32.

In step S32, the local map combination unit 221 controls the communication unit 205 to acquire the local map transmitted from the client device 111 and stores the local map in the storage unit 204 in association with the information for identifying the client device 111.

In step S33, the local map combination unit 221 determines whether or not a predetermined time has elapsed, and, in a case where it is determined that the predetermined time has not elapsed, the processing returns to step S31. That is, the processing of receiving transmission of a local map from the client device 111 is repeated until the predetermined time elapses.

Then, in a case where it is determined that the predetermined time has elapsed in step S33, the processing proceeds to step S34. Note that the processing may proceed to the processing in step S34 every time the local map is received, and, in this case, the processing in step S33 may be deleted.

In step S34, the local map combination unit 221 combines the local maps from all the client devices 111 stored in the storage unit 204. More specifically, the local map combination unit 221 repeats the processing of combining the local maps from all the client devices 111 stored in the storage unit 204 by the method described with reference to FIG. 11.

In step S35, the local map combination unit 221 determines whether or not the combination of the local maps has failed and the SLAM initialization for a global map has failed.

More specifically, in the processing in step S34, when the local maps cannot be combined with some cause in the processing of combining all the local maps, it is determined that the combination of the local maps has failed at that point of time.

Conversely, when all the local maps can be combined without any particular failure, it is considered that the combination of the local maps has not failed, that is, has been successfully performed.

In a case where it is determined in step S35 that the combination of the local maps has failed and the SLAM initialization for a global map has failed, the processing proceeds to step S36.

In step S36, the local map combination unit 221 specifies a cause of the combination failure.

In step S37, the local map combination unit 221 executes failure notification processing, generates guide information for solving the failure according to the cause of the combination failure, and notifies the client device 111 of the guide information. Then, the processing returns to step S31. At this time, the local map combination unit 221 resets the elapsed time in step S33 and deletes the local maps stored in the storage unit 204.

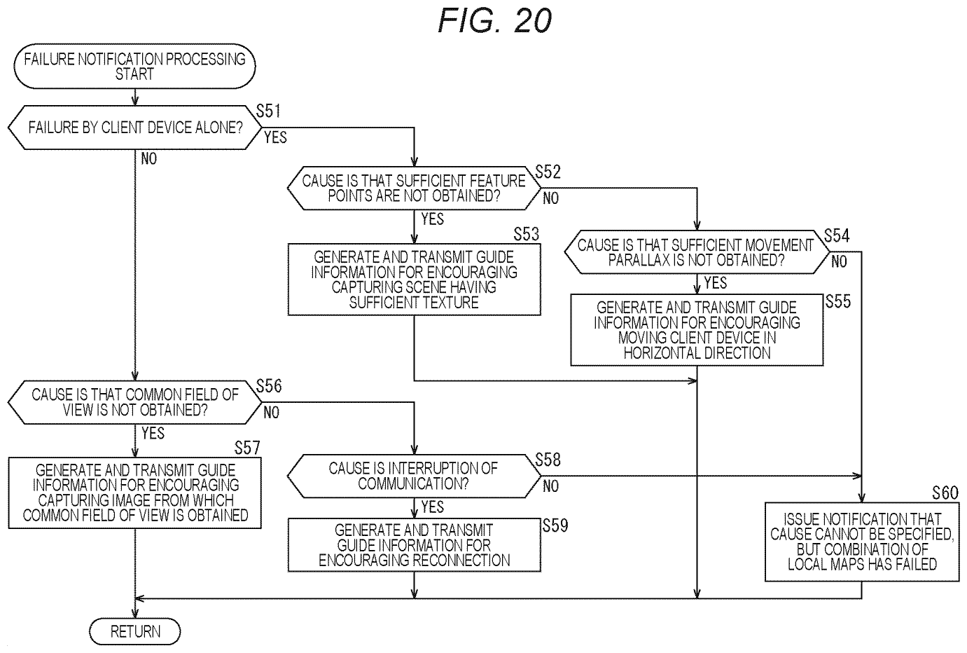

That is, the processing in steps S31 to S37 is repeated until all local maps are combined and the SLAM initialization for a global map is completed. Note that details of the failure notification processing in step S37 will be described later with reference to a flowchart of FIG. 20.

Then, in a case where it is determined in step S35 that the combination of the local maps has not failed and the SLAM initialization for a global map has successfully performed, the processing proceeds to step S38.

In step S38, the local map combination unit 221 controls the communication unit 205 to notify the client device 111 stored in association with the local map stored in the storage unit 204 that the combination of the local maps has been successfully performed and the SLAM initialization for a global map has been completed.

In step S39, the local map combination unit 221 stores the generated global map in the storage unit 204. In response to this, the position estimation unit 222 estimates a position and posture of each client device 111 from information of the local map of each client device on the basis of the global map and controls the communication unit 205 to transmit position information of each client device 111 to the client device 111. Then, the processing ends.

With this processing, the SLAM initialization for a global map is completed, a global map is formed and stored in the storage unit 204, and the position and posture of each client device are estimated and transmitted to each client device 111.

Further, hereinafter, the global map update unit 223 repeats processing of sequentially updating the global map stored in the storage unit 204 on the basis of a local map transmitted from the client device 111 as information of a reference coordinate system of the global map.

Meanwhile, in the client device 111, in step S16 (FIG. 18), the SLAM processing unit 151 controls the communication unit 135 to determine whether or not a notification of successful combination of the local maps has been issued from the server 112.

In step S16, in a case where the notification of successful combination of the local maps has not been issued, that is, in a case where guide information according to the cause of the failure of the combination of the local maps has been issued, the processing proceeds to step S17.

In step S17, the SLAM processing unit 151 controls the communication unit 135 to acquire the guide information according to the cause of the failure of the combination of the local maps transmitted from the server 112.

In step S18, the SLAM processing unit 151 controls the display unit of the output unit 133 to present the acquired guide information, and the processing returns to step S14.

That is, the processing in steps S14 to S18 is repeated, and the processing of acquiring guide information according to the cause of the combination failure transmitted from the server 112 and presenting the guide information to the user is repeated until the local maps are successfully combined.

Then, in step S16, in a case where the notification of successful combination of the local maps, that is, a notification of success in the SLAM initialization for a global map is issued, the processing proceeds to step S17.

In step S19, the SLAM processing unit 151 controls the communication unit 135 to acquire information of its own position and posture in the reference coordinate system of the global map transmitted from the server 112.

Therefore, hereinafter, the SLAM processing unit 151 can generate a local map generated in its own SLAM processing as information of the reference coordinate system of the global map and, when sequentially transmitting the local map to the server 112, can achieve update of the global map in the server 112.

With the above processing, the guide information according to the cause of the combination failure is displayed until the local maps are successfully combined. Therefore, the user can recognize the cause of the combination failure, and, when an operation that may solve the failure is presented as the guide information, the user can easily solve the combination failure by the user's own action.

### <Failure Notification Processing>

Next, the failure notification processing will be described with reference to the flowchart of FIG. 20.

In step S51, the local map combination unit 221 determines whether or not the cause of the failure of the combination of the local maps is the combination failure by the client device 111 alone.

In a case where it is determined in step S51 that the cause is the combination failure by the client device 111 alone, the processing proceeds to step S52.

In step S52, the local map combination unit 221 determines whether or not the cause of the combination failure is that sufficient feature points are not obtained.

In a case where it is determined in step S52 that the cause of the combination failure is that sufficient feature points (key points) are not obtained, the processing proceeds to step S53.

In step S53, the local map combination unit 221 generates guide information for encouraging capturing a scene having sufficient texture and controls the communication unit 205 to transmit the guide information to the client device 111.

The guide information for encouraging capturing a scene having sufficient texture is, for example, the guide information 281 including the comment guide 281a and the feature point gauge 281b described with reference to FIG. 16, and, when the feature point gauge 281b is displayed, it is possible to cause the user to recognize that sufficient feature points are not obtained. Further, the user can recognize whether or not a scene having sufficient texture is captured while viewing the ratio of white squares of the feature point gauge 281b.

Therefore, the user can select and capture a scene while capturing various images and recognizing which scene is an image having sufficient texture. As a result, it is possible to lead to combination of the local maps, that is, to successful SLAM initialization for a global map.

In a case where it is determined in step S52 that the cause of the combination failure is not that sufficient feature points are not obtained, the processing proceeds to step S54.

In step S54, the local map combination unit 221 determines whether or not the cause is that the three-dimensional coordinates of the landmark are not obtained because sufficient motion parallax is not obtained.

In a case where it is determined in step S54 that the cause is that the three-dimensional coordinates of the landmark are not obtained because sufficient motion parallax is not obtained, the processing proceeds to step S55.

In step S55, the local map combination unit 221 generates guide information for encouraging moving the client device in the horizontal direction and controls the communication unit 205 to transmit the guide information to the client device 111.

The guide information for encouraging moving the client device in the horizontal direction is, for example, the guide information 291 described with reference to FIG. 17, and, when the guide information 291 is displayed, the user can recognize that the cause of the combination failure is that the three-dimensional coordinates of the landmark are not obtained because sufficient motion parallax is not obtained. Further, with the guide information 281, the user can recognize that the failure of the combination of the local maps may be solved by moving the client device 111 in the horizontal direction.

Therefore, the user can perform an operation to forcibly generate the motion parallax, and, as a result, it is possible to lead to combination of the local maps, that is, to successful SLAM initialization for a global map.

In a case where it is determined in step S51 that the cause is not the combination failure by the client device 111 alone, it is considered that the cause is a failure at the time of combining the local maps, and the processing proceeds to step S56.

In step S56, the local map combination unit 221 determines whether or not the cause of the combination failure is that the common field of view is not obtained between a plurality of local maps.

In a case where it is determined in step S56 that the cause of the combination failure is that the common field of view is not obtained between the plurality of local maps, the processing proceeds to step S57.

In step S57, the local map combination unit 221 generates guide information for encouraging capturing an image from which the common field of view is obtained and controls the communication unit 205 to transmit the guide information to the client device 111.

Here, the guide information for encouraging capturing an image from which the common field of view is obtained is, for example, the guide information 261 and 261′ described with reference to FIG. 14, and, by displaying with which client device 111 the local maps have been successfully combined and with which client device 111 the local maps have not been successfully combined, it is possible to recognize which image having the same common field of view with which client device 111 is to be captured.

Therefore, for example, the user can perform an operation of capturing an image of the same subject in coordination with a user who has failed to combine the local map. This makes it possible to generate the common field of view.

As a result, it is possible to lead to successful combination of the local maps.

In a case where it is determined in step S56 that the cause of the combination failure is not that the common field of view is not obtained between the plurality of local maps, the processing proceeds to step S58.

In step S58, the local map combination unit 221 determines whether or not the cause of the failure of the combination of the local maps is interruption of communication.

In a case where it is determined in step S58 that the cause of the failure of the combination of the local maps is interruption of communication, the processing proceeds to step S59.

In step S59, the local map combination unit 221 generates guide information for encouraging reconnection and controls the communication unit 205 to transmit the guide information to the client device 111.

Here, the guide information for encouraging reconnection is, for example, display of the guide information 271 or the like described with reference to FIG. 15. This allows the user to recognize that the cause of the connection failure is interruption of communication. Further, the user can recognize that the failure may be solved by reconnection.

Therefore, for example, the user can control the communication unit 135 to perform a reconnection operation.

As a result, it is possible to lead to successful combination of the local maps.

In a case where it is determined in step S54 that the cause is not that sufficient motion parallax is not obtained, or in a case where it is determined in step S58 that the cause is not interruption of communication, the processing proceeds to step S60.

In step S60, the local map combination unit 221 controls the communication unit 205 to issue a notification that the cause cannot be specified, but the combination of the local maps has failed, and the SLAM initialization for a global map has not been implemented.

Therefore, the user can recognize that the combination of the local maps has failed with some cause other than not obtaining sufficient key points serving as feature points, not obtaining sufficient motion parallax, not obtaining the common field of view, or interruption of communication.

With the above processing, the failure of the combination of the local maps and the failure of the SLAM initialization for a global map are issued together with the cause thereof, and guide information for solving the failure according to the cause is presented.

Therefore, the user can recognize that the combination of the local maps, that is, the SLAM initialization for a global map has failed together with the cause.

Further, when the guide information for solving the failure according to the cause is presented, the user can successfully combine the local maps by his/her action even if the combination of the local maps has failed.

As a result, it is possible to more comfortably use the application program to which XR technology is applied.

### 2. Application Example

Hereinabove, there has been described an example where, in a case where the combination of the local maps, that is, the SLAM initialization for a global map fails, and the cause thereof is that the common view is not obtained, the guide information in FIG. 14 causes the user to recognize with which local map his/her own local map has been combined and with which local map his/her own local map has not been combined, and thus image capturing is performed to obtain the common field of view in coordination with a user whose local map has not been combined, thereby solving the combination failure.

However, an image captured by the client device 111 of the user whose local map has not been combined may be subjected to object recognition processing, then a subject required to form the common field of view may be specified on the basis of an object recognition result, and guide information for encouraging capturing an image of the specified subject may be presented.

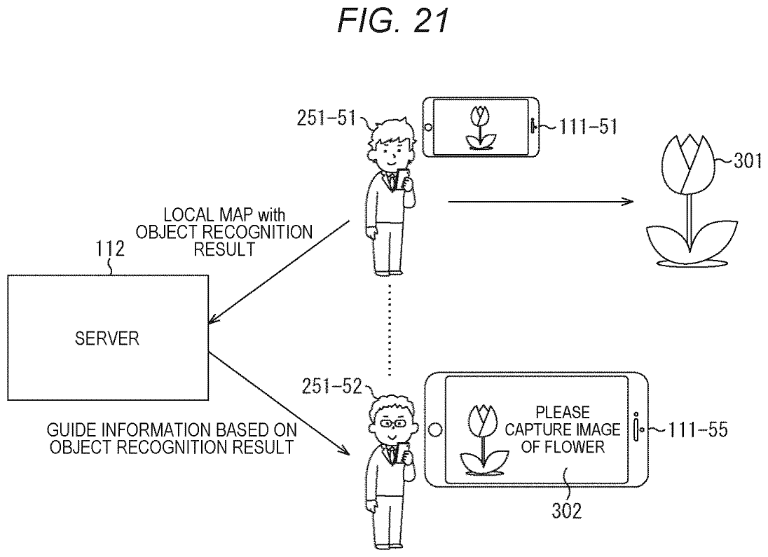

For example, as shown in FIG. 21, when a subject 301 including a flower is captured by a client device 111-51 possessed by a user 251-51, and the fact that the subject is a “flower” is recognized by the object recognition processing, the client device 111-51 transmits the local map in association with the object recognition result showing “flower” to the server 112.

When local maps are combined as the SLAM initialization processing for a global map, the server 112 generates guide information 302 such as “Please capture image of flower” shown in a client device 111-52 of FIG. 21 on the basis of information of the “flower” that is the object recognition result and transmits the guide information to the client device 111-52 whose local map cannot be combined with the local map of the client device 111-51 because the common field of view is not obtained.

When acquiring the guide information 302 such as “Please capture image of flower”, the client device 111-52 controls the display unit of the output unit 133 of an output unit 113-52 to present the guide information.

Therefore, a user 251-52 cannot recognize with which client device 111 possessed by which user 251 the client device 111-52 possessed by the user has failed to combine the local maps, but can recognize that the combination of the local maps has failed.

Further, by presenting the guide information 302 in FIG. 21, the user 251-52 can recognize that the combination failure may be solved by capturing an image of the subject 301 including the “flower” by using the client device 111-52 possessed by the user.

### <Application Example of Client Device>

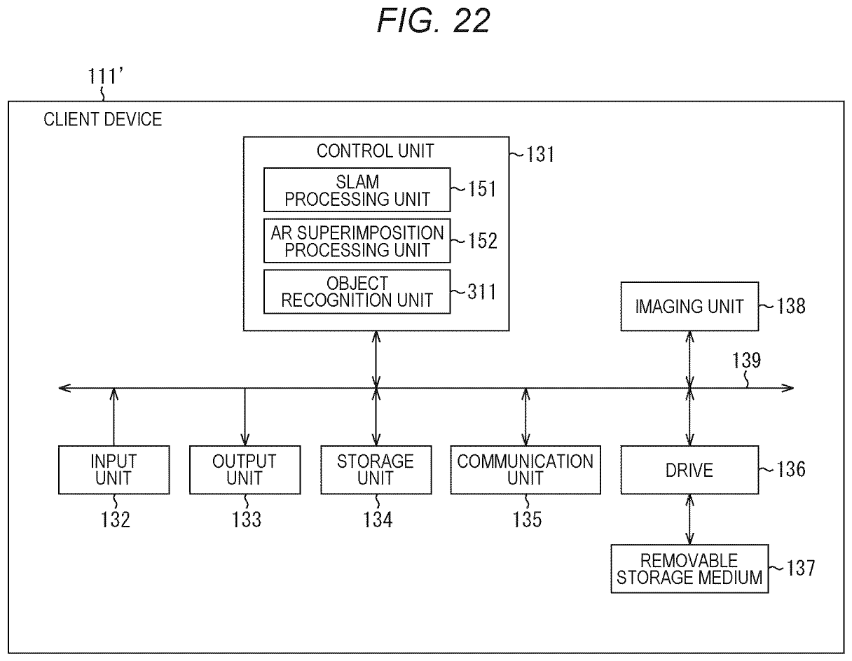

Next, a configuration example of a client device that presents guide information for encouraging capturing an image of a subject required to form the common field of view will be described with reference to FIG. 22.

A client device 111′ in FIG. 22 basically has the same function as the client device 111 in FIG. 7, but is different in newly including an object recognition unit 311.

The object recognition unit 311 recognizes an object on the basis of an image by, for example, machine learning such as deep learning, executes object recognition processing in the image used as a key frame in the SLAM processing unit 151, and supplies an object recognition result to the SLAM processing unit 151.

The SLAM processing unit 151 generates a local map, attaches the corresponding object recognition result thereto, and controls the communication unit 135 to transmit the local map to the server 112. Further, when the guide information 302 in FIG. 21 is transmitted from the server 112, the SLAM processing unit 151 acquires the guide information 302 and controls the display unit of the output unit 133 to present the guide information.

Here, in a case where the combination fails because the common field of view is not obtained, for example, as shown in FIG. 21, the local map combination unit 221 of the server 112 generates the guide information 302 in FIG. 21 on the basis of the object recognition result and transmits the guide information to the client device 111-52 that has not obtained the common field of view with the client device 111-51 that has transmitted the local map together with the object recognition result.

### <Application Example of SLAM Initialization Processing>

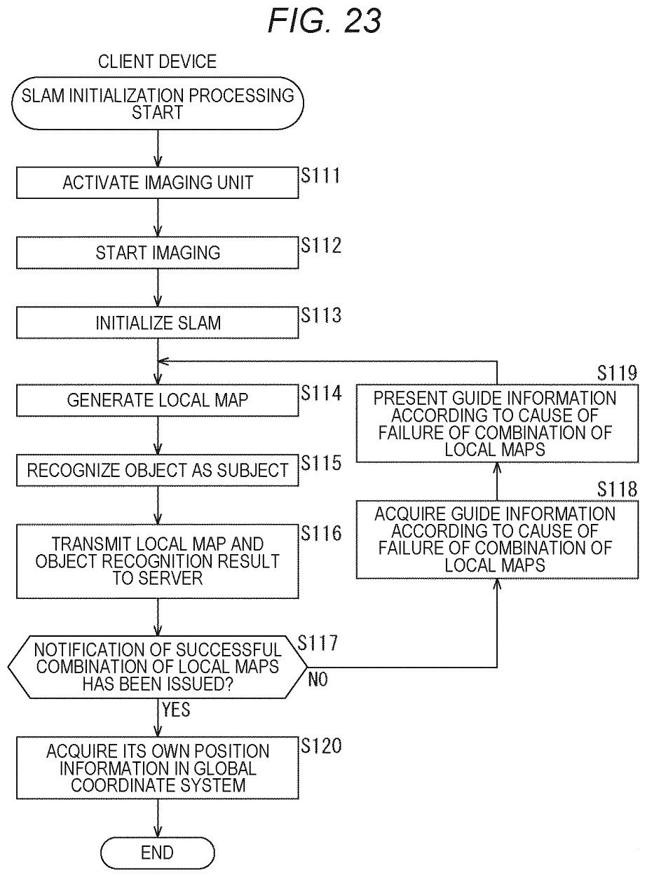

Next, SLAM initialization processing by the client device 111′ in FIG. 22 will be described with reference to a flowchart in FIG. 23. Note that processing in steps S111 to S114 and S117 to S120 of the flowchart in FIG. 23 is similar to the processing in steps S11 to S14 and S16 to S19 in FIG. 18, and thus the description thereof is omitted.

That is, when a local map is generated in the processing in steps S111 to S114, the processing proceeds to step S115.

In step S115, the object recognition unit 311 executes the object recognition processing in an image used as a key frame and supplies the object recognition result to the SLAM processing unit 151.

In step S116, the SLAM processing unit 151 controls the communication unit 135 to transmit the generated local map and the object recognition result in association with each other to the server 112.

With this processing, when the combination fails because the common field of view is not obtained, the guide information 302 in FIG. 21 is generated in the server 112 in the failure notification processing, is acquired in step S118, and is presented in step S119.

Note that the SLAM initialization processing in the server 112 is similar to the processing described with reference to the flowchart in FIG. 19, and thus description thereof is omitted.

### <Application Example of Failure Notification Processing>

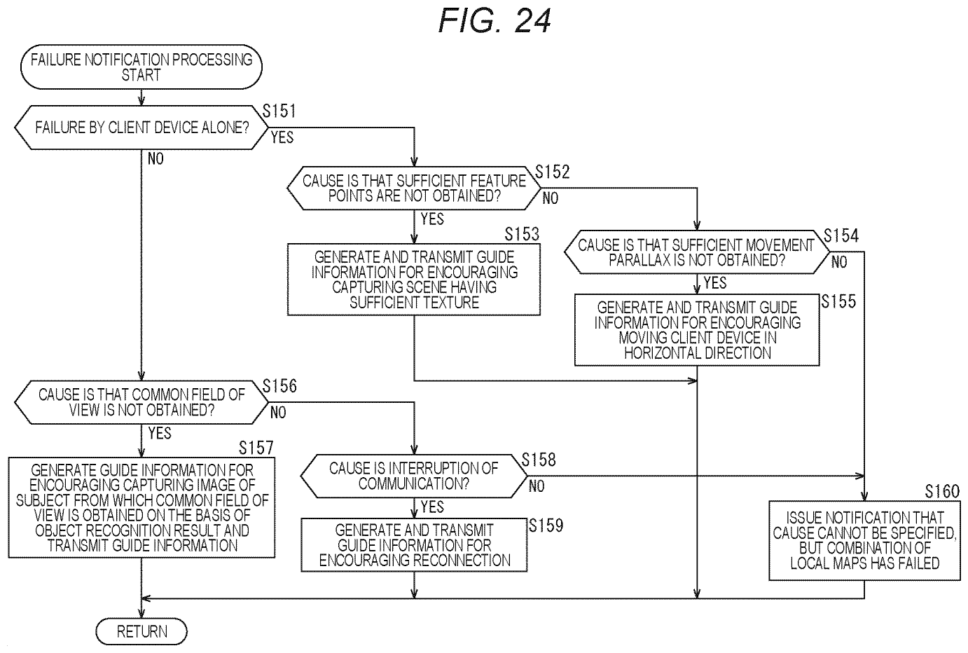

Next, an application example of the failure notification processing by the server 112 will be described with reference to a flowchart in FIG. 24.

Note that the processing in steps S151 to S156 and S158 to S160 of the flowchart in FIG. 24 is similar to the processing in steps S51 to S56 and S58 to S60 in FIG. 20, and thus description thereof is omitted.

That is, in a case where it is determined in step S156 that the cause of the combination failure is that the common field of view is not obtained between the plurality of local maps, the processing proceeds to step S157.

In step S157, the local map combination unit 221 generates guide information for encouraging capturing an image from which the common field of view is obtained and controls the communication unit 205 to transmit the guide information to the client device 111.

Here, the guide information for encouraging capturing an image from which the common field of view is obtained is, for example, the guide information 302 described with reference to FIG. 21, and, based on the object recognition result attached to the local map supplied from the client device 111, the local map combination unit 221 generates guide information for encouraging another client device 111 that has failed to combine the local map to image a subject corresponding to the object recognition result.

When the guide information 302 is presented, the user cannot recognize with which client device 111 the local map has not been combined, but can recognize that an image having the same common field of view can be captured by capturing an image of a target subject.

Therefore, for example, the user can perform an operation of capturing an image of the same subject in coordination with the another client device 111 who has failed to combine the local map. This makes it possible to generate the common field of view.

As a result, it is possible to lead to combination of the local maps, that is, successful SLAM initialization for a global map.

Note that, hereinabove, there has been described an example where the server 112 acquires local maps from the client device 111, combines the local maps to generate a global map, and, in a case where the combination fails, transmits guide information according to the cause of the failure.

However, in a case where the client device 111 has high functionality and can implement processing equivalent to that of the server 112, any of the plurality of client devices 111 may implement the function of the server 112 as a representative.

### 3. Example Executed by Software

Meanwhile, a series of processing described above can be executed by hardware or can also be executed by software. In a case where the series of processing is performed by software, a program constituting the software is installed from a recording medium into, for example, a computer built into dedicated hardware or a general-purpose computer capable of performing various functions by installing various programs.

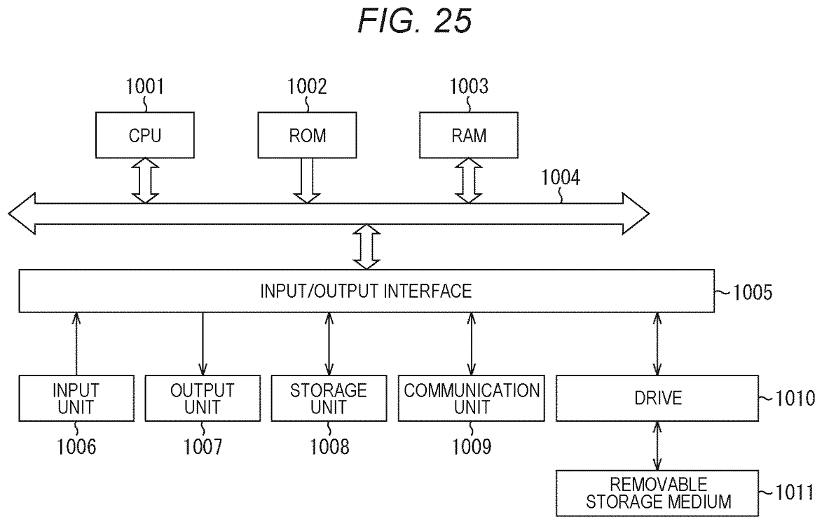

FIG. 25 shows a configuration example of a general-purpose computer. This computer includes a central processing unit (CPU) 1001. The CPU 1001 is connected to an input/output interface 1005 via a bus 1004. A read only memory (ROM) 1002 and a random access memory (RAN) 1003 are connected to the bus 1004.

The input/output interface 1005 is connected to an input unit 1006 including an input device such as a keyboard or a mouse with which the user inputs an operation command, an output unit 1007 that outputs a processing operation screen and an image of a processing result to a display device, a storage unit 1008 including a hard disk drive or the like that stores programs and various types of data, and a communication unit 1009 that includes a local area network (LAN) adapter or the like and executes communication processing via a network represented by the Internet. Further, a drive 1010 that reads and writes data from and to a removable storage medium 1011 such as a magnetic disk (including flexible disk), an optical disc (including compact disc-read only memory (CD-ROM) and digital versatile disc (DVD)), a magneto-optical disk (including mini disc (MD)), or a semiconductor memory is connected.

The CPU 1001 performs various types of processing according to a program stored in the ROM 1002 or a program read from the removable storage medium 1011 such as a magnetic disk, an optical disc, a magneto-optical disk, or a semiconductor memory, installed in the storage unit 1008, and loaded from the storage unit 1008 into the RAM 1003. Further, the RAM 1003 also appropriately stores data necessary for the CPU 1001 to perform various types of processing, and the like.

In the computer configured as described above, for example, the CPU 1001 loads the program stored in the storage unit 1008 into the RAM 1003 via the input/output interface 1005 and the bus 1004 and executes the program, thereby performing the above-described series of processing.

The program executed by the computer (CPU 1001) can be provided by being recorded in the removable storage medium 1011 as a package medium or the like, for example. Further, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Further, the program can be received by the communication unit 1009 via a wired or wireless transmission medium and installed in the storage unit 1008. Further, the program can be installed in the ROM 1002 or the storage unit 1008 in advance.

Note that the program executed by the computer may be a program in which processing is performed in time series in the order described in the present specification or may be a program in which processing is performed in parallel or at necessary timing such as when a call is made.

Note that the CPU 1001 in FIG. 22 implements the functions of the control units 131 and 201 in FIGS. 7, 8, and 22.

Further, in the present description, a system is intended to mean assembly of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Note that embodiments of the present disclosure are not limited to the embodiments described above, and various modifications may be made without departing from the scope of the present disclosure.

For example, the present disclosure may have a configuration of cloud computing in which one function is shared by a plurality of devices via a network and processing is performed in cooperation.

Further, each step described in the flowchart described above can be performed by one device or can be shared and performed by a plurality of devices.

Furthermore, in a case where a plurality of pieces of processing is included in one step, the plurality of pieces of processing included in the one step can be performed by one device or shared and performed by a plurality of devices.

Note that the present disclosure may also have the following configurations.

<1> An information processing device including
a generation unit that generates a global map by combining local maps generated by a respective plurality of other information processing devices, in which
in a case where the combination of the local maps fails, the generation unit presents guide information for solving the failure of the combination of the local maps.

<2> The information processing device according to <1>, in which
in a case where the combination of the local maps fails, the generation unit presents the guide information for solving the failure according to a type of cause of the failure of the combination of the local maps.

<3> The information processing device according to <2>, in which
the type of the cause of the failure of the combination of the local maps includes a cause occurring at the time of combining the local maps and a cause occurring at the time of generating the local maps.

<4> The information processing device according to <3>, in which
among the types of the cause of the failure of the combination of the local maps, the cause occurring at the time of combining the local maps includes a cause occurring due to not including a common field of view in a key frame forming the local map and a cause occurring due to interruption of communication regarding transfer of the local map.

<5> The information processing device according to <4>, in which
in a case where the cause of the failure of the combination of the local maps is the cause occurring at the time of combining the local maps and is the cause occurring due to not including the common field of view in the key frame forming the local map, the generation unit presents information for encouraging capturing an image having the common field of view as the guide information for solving the failure of the combination of the local maps.

<6> The information processing device according to <5>, in which
the generation unit indicates a group of the other information processing devices in which the combination of the local maps has been successfully performed and a group of the other information processing devices in which the combination of the local maps has failed and presents, as the guide information for solving the failure of the combination of the local maps, information for encouraging capturing an image having the common field of view with the other information processing devices belonging to the group in which the combination of the local maps has failed.

<7> The information processing device according to <5>, in which
the generation unit presents the information for encouraging capturing an image having the common field of view as the guide information for solving the failure of the combination of the local maps by indicating information of a subject captured by the other information processing devices in which the combination of the local maps has failed and encouraging capturing an image of the subject.

<8> The information processing device according to <7>, in which
the subject is an object recognition result of an image serving as the key frame forming the local map generated by each of the other information processing devices in which the combination of the local maps has failed.

<9> The information processing device according to <4>, in which
in a case where the cause of the failure of the combination of the local maps is the cause occurring at the time of combining the local maps and is the cause occurring due to interruption of the communication regarding the transfer of the local map, the generation unit presents information for encouraging reconnection of the communication as the guide information for solving the failure of the combination of the local maps.

<10> The information processing device according to <3>, in which
among the types of the cause of the failure of the combination of the local maps, the cause occurring at the time of generating the local maps includes a cause occurring due to not obtaining a sufficient number of key points from a key frame forming the local map and a cause occurring due to not obtaining motion parallax for obtaining three-dimensional coordinates of a landmark in the key frame.

<11> The information processing device according to <10>, in which
in a case where the cause of the failure of the combination of the local maps is the cause occurring at the time of generating the local maps and is the cause occurring due to not obtaining the sufficient number of key points from the key frame forming the local map, the generation unit presents information for encouraging capturing an image having sufficient texture as the guide information for solving the failure of the combination of the local maps.

<12> The information processing device according to <11>, in which
the generation unit presents, as the guide information for solving the failure of the combination of the local maps, the information for encouraging capturing an image having the sufficient texture and information indicating a ratio of the number of current key points obtained from the key frame to the minimum required number of key points.

<13> The information processing device according to <11>, in which
the generation unit presents, as the guide information for solving the failure of the combination of the local maps, the information for encouraging capturing an image having the sufficient texture and information indicating a ratio of the number of regions satisfying a condition that more key points are obtained than the minimum required number of key points in units of regions when the key frame is divided into regions of a fixed size to the minimum required number of regions.

<14> The information processing device according to <10>, in which
in a case where the cause of the failure of the combination of the local maps is the cause occurring at the time of generating the local maps and is the cause occurring due to not obtaining the motion parallax for obtaining the three-dimensional coordinates of the landmark in the key frame, the generation unit presents information for encouraging capturing an image while moving in a horizontal direction as the guide information for solving the failure of the combination of the local maps.

<15> The information processing device according to any one of <1> to <14>, in which
the generation unit combines the local maps by performing conversion into a common coordinate system on the basis of three-dimensional coordinates of a common landmark between key frames forming the local maps generated by the other information processing devices different from each other.

<16> The information processing device according to any one of <1> to <15>, in which
the local map is generated by simultaneous localization and mapping (SLAM) executed in the other information processing devices.

<17> An information processing method including the steps of:
generating a global map by combining local maps generated by a respective plurality of other information processing devices; and
in a case where the combination of the local maps fails, presenting guide information for solving the failure of the combination of the local maps.

<18> A program for causing a computer to function as
a generation unit that generates a global map by combining local maps generated by a respective plurality of other information processing devices, in which
in a case where the combination of the local maps fails, the generation unit presents guide information for solving the failure of the combination of the local maps.

### REFERENCE SIGNS LIST

101 Communication system
111, 111-1 to 111-n Client device
112 Server
151 SLAM processing unit
152 AR superimposition processing unit
221 Local map combination unit
222 Position estimation unit
223 Global map update unit
311 Object recognition unit

1. An information processing device comprising
a generation unit that generates a global map by combining local maps generated by a respective plurality of other information processing devices, wherein
in a case where the combination of the local maps fails, the generation unit presents guide information for solving the failure of the combination of the local maps.

2. The information processing device according to claim 1, wherein
in a case where the combination of the local maps fails, the generation unit presents the guide information for solving the failure according to a type of cause of the failure of the combination of the local maps.

3. The information processing device according to claim 2, wherein
the type of the cause of the failure of the combination of the local maps includes a cause occurring at the time of combining the local maps and a cause occurring at the time of generating the local maps.

4. The information processing device according to claim 3, wherein
among the types of the cause of the failure of the combination of the local maps, the cause occurring at the time of combining the local maps includes a cause occurring due to not including a common field of view in a key frame forming the local map and a cause occurring due to interruption of communication regarding transfer of the local map.

5. The information processing device according to claim 4, wherein
in a case where the cause of the failure of the combination of the local maps is the cause occurring at the time of combining the local maps and is the cause occurring due to not including the common field of view in the key frame forming the local map, the generation unit presents information for encouraging capturing an image having the common field of view as the guide information for solving the failure of the combination of the local maps.

6. The information processing device according to claim 5, wherein
the generation unit indicates a group of the other information processing devices in which the combination of the local maps has been successfully performed and a group of the other information processing devices in which the combination of the local maps has failed and presents, as the guide information for solving the failure of the combination of the local maps, information for encouraging capturing an image having the common field of view with the other information processing devices belonging to the group in which the combination of the local maps has failed.

7. The information processing device according to claim 5, wherein
the generation unit presents the information for encouraging capturing an image having the common field of view as the guide information for solving the failure of the combination of the local maps by indicating information of a subject captured by the other information processing devices in which the combination of the local maps has failed and encouraging capturing an image of the subject.

8. The information processing device according to claim 7, wherein
the subject is an object recognition result of an image serving as the key frame forming the local map generated by each of the other information processing devices in which the combination of the local maps has failed.

9. The information processing device according to claim 4, wherein
in a case where the cause of the failure of the combination of the local maps is the cause occurring at the time of combining the local maps and is the cause occurring due to interruption of the communication regarding the transfer of the local map, the generation unit presents information for encouraging reconnection of the communication as the guide information for solving the failure of the combination of the local maps.

10. The information processing device according to claim 3, wherein
among the types of the cause of the failure of the combination of the local maps, the cause occurring at the time of generating the local maps includes a cause occurring due to not obtaining a sufficient number of key points from a key frame forming the local map and a cause occurring due to not obtaining motion parallax for obtaining three-dimensional coordinates of a landmark in the key frame.

11. The information processing device according to claim 10, wherein
in a case where the cause of the failure of the combination of the local maps is the cause occurring at the time of generating the local maps and is the cause occurring due to not obtaining the sufficient number of key points from the key frame forming the local map, the generation unit presents information for encouraging capturing an image having sufficient texture as the guide information for solving the failure of the combination of the local maps.

12. The information processing device according to claim 11, wherein
the generation unit presents, as the guide information for solving the failure of the combination of the local maps, the information for encouraging capturing an image having the sufficient texture and information indicating a ratio of the number of current key points obtained from the key frame to the minimum required number of key points.

13. The information processing device according to claim 11, wherein
the generation unit presents, as the guide information for solving the failure of the combination of the local maps, the information for encouraging capturing an image having the sufficient texture and information indicating a ratio of the number of regions satisfying a condition that more key points are obtained than the minimum required number of key points in units of regions when the key frame is divided into regions of a fixed size to the minimum required number of regions.

14. The information processing device according to claim 10, wherein
in a case where the cause of the failure of the combination of the local maps is the cause occurring at the time of generating the local maps and is the cause occurring due to not obtaining the motion parallax for obtaining the three-dimensional coordinates of the landmark in the key frame, the generation unit presents information for encouraging capturing an image while moving in a horizontal direction as the guide information for solving the failure of the combination of the local maps.

15. The information processing device according to claim 1, wherein
the generation unit combines the local maps by performing conversion into a common coordinate system on a basis of three-dimensional coordinates of a common landmark between key frames forming the local maps generated by the other information processing devices different from each other.

16. The information processing device according to claim 1, wherein
the local map is generated by simultaneous localization and mapping (SLAM) executed in the other information processing devices.

17. An information processing method comprising the steps of:
generating a global map by combining local maps generated by a respective plurality of other information processing devices; and
in a case where the combination of the local maps fails, presenting guide information for solving the failure of the combination of the local maps.

18. A program for causing a computer to function as
a generation unit that generates a global map by combining local maps generated by a respective plurality of other information processing devices, wherein
in a case where the combination of the local maps fails, the generation unit presents guide information for solving the failure of the combination of the local maps.
